(19) United States
(12) Patent Application Publication
(10) Pub. No.: US 2021/0365940 A1
(43) Pub. Date: Nov. 25, 2021

(54) Transaction For Tamper and Quality Evidenced Delivery of Purchase Incented By Donation

(71) Applicant: Edatanetworks, Inc., Calgary, CA (US)

(72) Inventors: Terrance Patrick TIETZEN, Edmonton (CA); Matthew Arnold Macpherson BATES, Beaumont (CA); William Orey Letki, EDMONTON (CA)

(21) Appl. No.: 17/323,427

(22) Filed: May 18, 2021

Related U.S. Application Data
(60) Provisional application No. 63/029,601, filed on May 25, 2020.

(51) Int. Cl. G06Q 20/38; G06Q 20/40; G06Q 20/12; G06Q 10/08

(52) U.S. Cl. CPC G06Q 20/38215; G06Q 10/083; G06Q 20/12; G06Q 20/4015

(57) ABSTRACT

Incentives are offered by merchants, delivery services, issuers, acquirers, and transaction handlers are made to an account holder to make an authorized e-commerce transaction for the delivery of a purchase in exchange for the offerors making a donation to the account holder's designed charity. To incent purchases from local merchants, the incentive may limit the donation by a derivation of navigation time between account holder and merchant. The consumer uses any one of several different merchant websites to check-out so as to purchase the selected goods and services in the account holder's virtual shopping cart that the account holder selected from any of the several different merchant websites, while avoiding interacting with third party vendors. The consumer shops with different merchants at different webpages without requiring the account holder to use a separate permission or log-in for each different merchant. The account holder receives the packaged purchase in tamper evident packaging, and has access to chain of custody documentation and blockchain data sufficient to assure a certification of quality for the purchase in the delivered package. The consumer receives the package purchase from a delivery service by a process that is socially distanced with contactless acceptance of the packaged purchase. The consumer receives a survey by which feedback communications can be provided about the delivery of the packaged purchase.

### CROSS REFERENCE

This application claims priority to: (i) U.S. Provisional Application Ser. No. 63/029,601, filed on May 25, 2020, titled “Transaction For Tamper and Quality Evidenced Delivery of Purchase Incented By Donation,” and is related to: (ii) U.S. patent application Ser. No. 16/446,728, titled “Blockchain Tracking and Managing of A Transaction Incented By A Merchant Donation To A Consumer Affinity”, filed on Jun. 20, 2019, and published as US Patent Application Publication No 20190392489 on Dec. 26, 2019; (iii) U.S. patent application Ser. No. 16/014,843, titled “Non-Contact Biometric Identification System”, filed on Jun. 21, 2018, and published as US Patent Application Publication No. 20190392189 on Dec. 26, 2019; (iv) U.S. patent application Ser. No. 13/748,459, titled “Authorized Transaction Incented By Merchant Donation”, filed on Jan. 23, 2013, and published as US Patent Application Publication No 2014/0136300 on May 15, 2014; (v) U.S. patent application Ser. No. 14/973,918, titled “Devices, Systems And Methods For Managing Feedback In A Network Of Computing Resources”, filed on Dec. 18, 2015, and published as US Patent Application Publication No 2016-0180360 on Jun. 23, 2016; (vi) U.S. patent application Ser. No. 16/170,186, titled “Community Merchant Cross Selling/Promoting With Shared e-Commerce Shopping Cart For Items Selected By Community Residents Incented To Conduct Transactions To Incent Community Donations”, filed on Oct. 25, 2018, and published as US Patent Application Publication No 20190130462 on May 2, 2019; and (vii) U.S. Pat. No. 10,977,604, titled “Systems for routing and controlling vehicles for freight,” issued on Apr. 13, 2021. Each of (i) through (vii) are hereby incorporated herein by reference.

### FIELD

Implementations generally relate to facilitating incentives offered by merchants and their allies to encourage purchases by consumers via conducting transactions on accounts issued to them by issuers in exchange for the merchants and their allies making donations to entities with whom the consumers have an affinity, where each transaction by the consumer from the merchant is for a purchase of a good or service for delivery to the consumer.

### BACKGROUND

Merchants often use techniques to prompt consumers into making a particular purchase. These techniques are commonly in the form of monetary incentives, relying on the principle that a lower price will result in increased sales. Merchants may employ these techniques, for example, to help clear inventory before a new season's merchandise is released, to ease the release of a new product, to increase sales near the end of the fiscal year, to compete with a competitor over particular products, or to generally spur sales. Monetary incentives may come in the form of a “sale” (i.e., temporary reduction in price at the register), a discount coupon, a mail-in rebate (i.e., a refund of part or the entire purchase price by mail), or a store credit (i.e., credit that can be applied to another store purchase). These incentives usually only apply to a particular product and have a time component. For example, a sale may only apply to a particular brand of dishwasher purchased on a particular holiday weekend and a rebate may only be valid for computers purchased within two weeks before the start of classes at a university.

For some credit transactions, a merchant may also use a statement credit as a monetary incentive. A statement credit is an amount refunded back to a credit account and appears on the account holder's account statement. Using a statement credit as a monetary incentive involves two distinct transactions. In the first transaction, the merchant charges the full amount to a customer's credit account. In the second transaction, the amount of the monetary incentive is then refunded back to the customer's credit account as a statement credit.

Statement credit campaigns offer an advantage for merchants over other types of monetary incentive programs because a transaction handler, such as Visa Inc. or MasterCard Inc., largely handles the administration of the campaign. Once a statement credit campaign is arranged and initiated between a merchant and a transaction handler, the transaction handler tracks the statement credit, matches the statement credit to qualifying purchases, and credits the amount of the statement credit to the purchaser's account. The transaction handler then collects the aggregate amount of the statement credits made to multiple purchasers from the merchant.

Although consumers are typically incented to make purchases by a form of price reduction, non-monetary reasons also motivate consumers to make purchases with a merchant. For instance, the charitable actions by and intentions of a merchant may demonstrate to a consumer that the merchant is a force for good such that the consumer is non-monetarily incented to do business with the merchant who the consumer deems worthy of such support. As such, it would be an advance in the art to provide other types of non-monetary incentive motivations to a consumer to conduct a transaction with a merchant.

Electronic commerce (e-commerce) is an effective, convenient and efficient way for shoppers to conduct transactions with merchants to buy goods and services. In prior art applications, the merchant having merchandise to offer typically implements a website at a merchant server, which may be maintained by the merchant's staff or hosted at a hosting facility. The merchant website typically includes a product database, representing the database of products to be sold, and a shopper database, representing the database of the merchant's shoppers and their respective profiles. To facilitate the transaction process, a variety of search, virtual shopping cart, and checkout tools may be provided. In general, these tools facilitate the interaction between a specific merchant website and the shopper. On the shopper's side, the interaction typically takes place through a software application installed on the user's computer device, or by way of an appropriate user interface at the shopper's computer terminal that may be executing a user interface in the form of a World Wide Web (www) browser (e.g., Google Chrome, Mozilla Firefox, Microsoft Internet Explorer, Bing, Opera).

In typical prior art e-commerce arrangements, a customer chooses an item (e.g., a product or service) for subsequent purchase by putting each item in a virtual shopping cart via a Web browser that browses each of several different Web virtual stores. The virtual shopping cart is maintained across multiple independent transaction sessions across heterogeneous websites each of which corresponds to a different merchant. The shopper is able to suspend a purchasing decision about any item in the virtual shopping cart while comparison shopping across unaffiliated merchant websites before making a decision about which products in the virtual shopping cart to buy. However, limitations of these prior art e-commerce arrangements are that they functions like a plug-in for a third party e-commerce browsing site, they require that multiple different servers must be used, that all of the vendors and their respective websites are unrelated, they require that the shopper use separate logins for each vendor website in order to check-out, and they require that the shopper use a check-out that is either an external vendor website or a third party partner website. During check-out, the shopper can select a delivery process for the purchase of one or more items in the virtual shopping cart, such as a home delivery of a food take out order from a merchant who is a restaurant or grocer.

As home delivery of consumer purchases, such as takeout meals, and third party delivery companies continue to grow in popularity, the need for takeout and delivery packaging evolves. For instance, peace of mind for customers receiving delivered meals is important for business owners, the consequence of which is a greater demand for tamper evident packaging. As such, it would be an advance in the art to provide deliveries, such as food delivery, in tamper evident packaging where the consumer ordering the delivery from the merchant has a non-monetary incentive that motivates the consumer to conduct a transaction for the food delivery.

As third party delivery companies continue to grow in popularity for home delivery of takeout meals, the need for ascertaining the “Chain of Custody” of a package to be delivered to a consumer becomes increasingly important. By way of example, a chain of custody is desirable to be established by way of a chronological documentation or paper trail, showing the packaging of a purchase that is to be delivered, successive custody of the packaged purchase, successive control of the packaged purchase, one or more places of transfer of the packaged purchase, and final delivery of the packaged purchase. Chain of custody ensures that only authorized individuals come in contact with the package, from the beginning of the packaging of the purchase to the ending action of delivery of the packaged purchase. In one such case, the courier process, signature capture, GPS time-stamp features, and barcoding can create an automated digital trail so as to create documentation on what the packaged purchase is, where the packaged purchase is or where the packaged purchase has been, who has possession of the packaged purchase at any given time, where the packaged purchase is going, etc. When the packaged purchase is so tracked from initial pick up until delivery to the designated final location, there is a closing of the loop on the courier process. As such, it would be an advance in the art to provide deliveries, such as food delivery, with chain of custody documentation for a packaged purchase where the consumer ordering the delivery from the merchant has a non-monetary incentive that motivates the consumer to conduct a transaction for the delivery of the packaged purchase.

With emerging technologies like Blockchain, Artificial Intelligence (AI), and the Internet of Things (IoT) powered solutions, various industries like healthcare, automotive, and more are developing safe, efficient, and transparent solutions to address various challenges. Food industry players are also exploring blockchain technology for solutions to address challenges. These challenges include, but are not limited to, fragmented supply chain processes, fraud, counterfeiting, foodborne disease, and more. By way of example, blockchain in the food industry uses a type of digital Distributed Ledger Technology (DLT) that records end-to-end information in a shared yet immutable manner with encryption mechanisms across the network of stakeholders. DLT ensures that no single entity gets the authority to access or manipulate information. As a result, DLT establishes trust, transparency, and efficiency in the network. Moreover, DLT eliminates the need to have one centralized system owned by a single governing body and thus, many other complexities. Food supply chain stakeholders, including manufacturers, processors, suppliers, retail food and meal sellers and their customers, when using the blockchain-powered ledger, can access end-to-end product records from their provenance to the dining table. Such blockchain supply chain management solutions can provide various advantages to the food industry stakeholders. By these food supply chain stakeholders' use of blockchain-powered provenance traceability, each can know where data came from while tracing the entire history of food that is being ordered by a consumer for home and/or business delivery. Additionally, with tamper evidence capabilities, each food supply chain stakeholder can access whether or not someone changed information, and each food supply chain stakeholder can also control what someone should see and perform actions at a data element level. As such, it would be an advance in the art to provide deliveries, such as food deliveries, with blockchain technology proving solutions to the problems of fragmented supply chain processes, fraud, counterfeiting, foodborne disease, and chain of custody documentation for a packaged purchase where the consumer ordering the delivery from the merchant has a non-monetary incentive that motivates the consumer to conduct a transaction for the delivery with the merchant.

Various legal jurisdictions have promulgated, due to public health concerns, both required and precatory stay at home guidelines. These promulgates have caused last mile deliveries to surge, especially for essential goods, such as takeout meals. Couriers are under pressure to deliver critical orders while also adhering to new safety protocols such as contactless delivery at the doorstep of the home or place of business of the customer to ensure driver and customer safety. Many last mile providers are increasing staffing levels for the delivery of critical orders to customers unable to leave their homes or businesses. Non-traditional fulfilment centers and distributed networks have recently emerged for such providers to cope with the rise in last mile deliveries. In addition, last mile providers are also utilizing connectivity applications allowing customers to request deliveries be left at their door and be alerted by text (e.g., SMS) or push notification. Other options allow customers not to sign in order to accept delivery, but to have the driver sign or offer a recorded proof-of-delivery. This trend is presenting a challenge for the delivery industry where several last mile deliveries are contracted to third-party carriers. These carriers must balance the requirements of safety and social distancing with the need for proof-of-delivery. As such, it would be an advance in the art to provide deliveries, such as food deliveries, by delivery services having the ability to provide a delivery to a consumer by a process that is socially distanced from the consumer, with the consumer's contactless acceptance of a packaged purchase from a merchant, and where the consumer ordering the delivery from the merchant has a non-monetary incentive that motivates the consumer to conduct a transaction for the delivery of the packaged purchase.

Loyalty program network communication systems may distribute and collect data relating to merchant transactions with customers that are members or cardholders of a loyalty program. The transaction data may detail transactions between the consumer (card holder), the merchant, and the delivery service that delivered a packaged purchase to the consumer, where the detail may include comments received back from a survey of the consumer about goods or services purchased, delivered, date, time, total cost, and so on. Loyalty program network communication systems may also enable merchants to provide communications to consumer regarding transactions, including offers and rewards. It may be desirable for a merchant to solicit and receive feedback from consumers regarding its transactions. There exists a need for improved feedback communications systems from consumers about the delivery of a packaged purchase, where the consumer ordering the delivery from the merchant has a non-monetary incentive that motivates the consumer to conduct a transaction for the delivery of a purchase in in the transaction with the merchant.

Given the above and other problems imposed upon shoppers and merchants in prior art electronic shopping systems and methods, it would be an advance in the relevant arts to provide methods and systems that have the following three (3) advantages: (i) allow the shopper to use any one of several different merchant websites to check-out so as to purchase the selected goods and services in the shopper's virtual shopping cart that the shopper selected from any of the several different merchant websites; (ii) allow the shopper to avoid interacting with third party vendors, such as when performing an electronic checkout function with the shopper's virtual shopping cart; and (iii) allow the shopper to shop with different merchants at different webpages without requiring the shopper to use a separate permission or log-in for each different merchant. These advantages provide a collection of affiliated and associated sites via a conglomerate under an umbrella site that creates benefits for the users and the business (merchant-members) because of their connectivity. As such, it would be an advance in the art to provide the above three (3) advantages to an e-commerce shopper placing an order for a purchase to be delivered by a delivery service, such as food delivery, where the shopper ordering the delivery from the merchant: (i) receives the packaged purchase in tamper evident packaging; (ii) has access to chain of custody documentation for the packaged purchase; (iii) has access to blockchain data sufficient to assure the shopper as to the quality for the purchase in the delivered package; (iv) takes delivery from a delivery service by a process that is socially distanced from the shopper by way of the shopper's contactless acceptance of the packaged purchase; and (v) receives a survey by which the shopper can provide feedback communications about both their purchase and the delivery of the packaged purchase.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIGS. 1-2 are flowcharts illustrating respective exemplary processes that allow an account holder to make a purchase of goods and/or services from a merchant, where the account holder's transaction obligates at least one of the merchant and a participate in a payment processing system to make a donation an affinity entity that make also be a charitable organization (e.g., a charity);

FIG. 3 illustrates an exemplary payment processing system in which the processes of FIGS. 1-2 can be performed, where the system processes transactions conducted by merchants with account holders, wherein, for each transaction, there is a provision of a service and/or good by the merchant to the account holder for the transaction which is conducted on an account issued to the account holder by an issuer, there is an authorizing and remunerating of an electronic payment by the account holder in conducting the transaction on the account with the merchant, and there are one or more donations by at least one of the merchant and a participate in a payment processing system that are made to respective affinity entities or charities incident to the transaction;

FIGS. 4a-4b illustrate screen shots characterizing exemplary user interfaces for a merchant to designate terms and conditions under which at least one of the merchant and a participate in a payment processing system will make a donation incident to each transaction with each account holder;

FIGS. 5a-5b illustrate screen shots characterizing exemplary user interfaces for an account holder to specify one or more affinity entities to whom a donation will be made by at least one of the merchant and a participate in a payment processing system, wherein the account holder conducts a transaction with a merchant on an account issued to the account holder, and optionally also for the account holder to specify one or more affinity entities to whom a donation by the account holder will be made when the account holder conducts a transaction with the merchant on their account so as to match at least a portion of the donation by the merchant;

FIG. 6 illustrates exemplary systems housed within an interchange center to provide online and offline transaction processing for transactions conducted using the payment processing system illustrated in FIG. 3;

FIG. 7 illustrates further exemplary details of the systems illustrated in FIG. 6; and

FIG. 8 is a flowchart illustrating an exemplary process that allows a community resident to purchase items from e-Commerce website corresponding to one or more merchants, where each purchased item will packaged in tamper evident packaging, where each tamper evident packaged purchase will be delivered to the community resident by a delivery service, and where each item purchased by the community resident obligates the corresponding merchant and delivery service make a donation to an affinity entity designed by the community resident.

Implementations will become more apparent from the detailed description set forth below when taken in conjunction with the drawings.

### DETAILED DESCRIPTION

Implementations disclosed herein provide incentives to an electronic commerce (e-commerce) consumer to make a purchase from a merchant for the delivery of the purchase in a package, where: (i) the incentive is a commitment from the merchant, or an ally of the merchant or the consumer, to make a donation to an entity designed by the consumer; (ii) the e-commerce consumer is allowed to use any one of several different merchant websites to check-out so as to purchase the selected goods and services in the shopper's virtual shopping cart that the shopper selected from any of the several different merchant websites. Each merchant will preferably have a physical location, such as a Brick and Mortar retail store that is located in the same community where the shopper resides. As such, each shopper can purchase goods and service from local merchants who are located in the community where the shopper resides; (ii) the e-commerce consumer avoids interacting with third party vendors, such as when performing an electronic checkout function with the shopper's virtual shopping cart, where the third party vendors are unrelated and unconnected; (iii) the e-commerce consumer is allowed to shop with different merchants at different webpages without requiring the shopper to use a separate permission or log-in for each different merchant; (iv) the consumer receives delivery of the packaged purchase in tamper evident packaging; (v) the consumer has access to chain of custody documentation for the packaged purchase; (vi) the consumer has access to blockchain data sufficient to assure a certification of quality for the purchase in the delivered package; (iv) the consumer takes delivery of the package purchase from a delivery service by a process that is socially distanced with contactless acceptance of the packaged purchase; and (v) the consumer receives a survey by which feedback communications can be provided about both items in the purchase and the delivery of the packaged purchase.

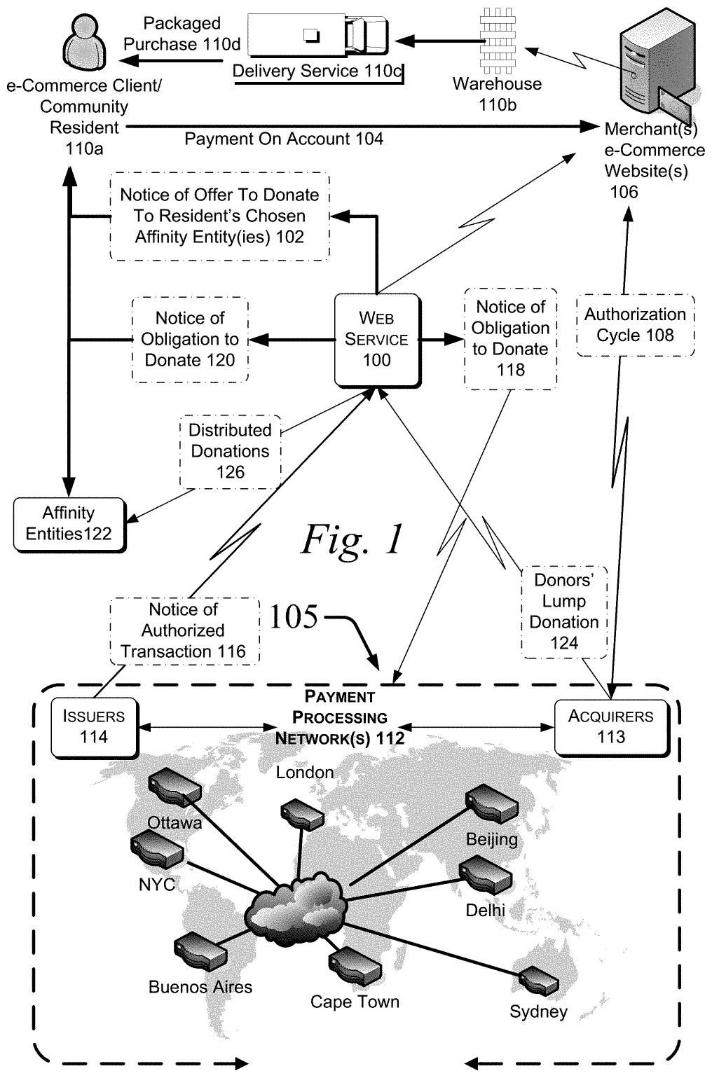

Referring now to FIG. 1, an environment is depicted for a global Acquired Account Payment Processing System 105 as shown. FIG. 1 shows a Community Resident 110a operating a client to conduct an e-commerce transaction via one or more Merchant e-Commerce Websites 106. The Community Resident 110a is incentivized to transact by way of an offer 102 from the merchant, or an ally of the merchant, to a make a donation to the Community Resident 110a's Affinity Entities 112 in exchange for the Community Resident 110a making a purchase to be delivered to the Community Resident 110a. The purchase is delivered as a Packaged Purchase 110d to the Community Resident 110a by way of a Delivery Service 110c. The Packaged Purchase 110d is received by Delivery Service 110c from a Warehouse 110b. When using the client to conduct the transaction with the merchant via the Merchant's e-Commerce Website 106, the Community Resident 110a makes a payment on an account 104 that was issued by an issuer 114 to the Community Resident 110a. Note that, in some implementations, the merchant, or an ally of the merchant, sets terms and conditions under which the donation will be made, while the Community Resident 110a selects one or more Affinities Entities 122 to which each such donation is to be made.

The merchant, who may be operating a brick and mortar store in the community where the Community Resident 110a resides, receives transaction data about the transaction in regards to the Community Resident 110a's account via the Merchant's e-Commerce Website 106 that transmits the input data, as part of an authorization request in an authorization cycle for the transaction, to an acquirer 113 for the merchant. Acquirer 113, who is one of many entities in an Acquired Account Payment Processing System 105, sends the authorization request through one or more Payment Processing Networks 112, as facilitated by one or more transaction handlers, to the issuer 112 who issued the account to the Community Resident 110a. In response to the authorization request, the issuer 112 sends an authorization response for ultimate delivery back to the Merchant's e-Commerce Website 106 by transmissions backwards through the Payment Processing Network 112 via the merchant's acquirer 113.

If the transaction is authorized by issuer 114, an entity in the global Acquired Account Payment Processing System 105, such as the issuer 114, sends a message 116 containing particulars of the transaction to a Web Service 100 indicating that a transaction on the Community Resident 110a's account was approved for being conducted by the Community Resident 110a with the merchant.

Optionally, the data input into the Merchant's e-Commerce Website 106 can include additional monies received from the Community Resident 110a's account, the issuer 114, the acquirer 113, and/or the Delivery Service 110c that are also to be donated to one or more Affinity Entities 112 (e.g., a local community service or charity) that were previously designated by the Community Resident 110a. In that case, message 116 would also contain these particulars, such as each donor that was making a donation to each of the one or more Affinity Entities 112 designated by the Community Resident 110a. Upon receipt of message 116, each donation to each of the one or more Affinity Entities 112 can be calculated according terms and conditions specified by each of the respective donors, namely the merchant from whom the Packaged Purchase 110d to be received by the Community Resident 110a, the Community Resident 110a, the issuer 114, the acquirer 113, the transaction handler for the issuer 114 and acquirer 113, the Warehouse 110b, and/or the Delivery Service 110c.

Merchants in a local community, for reasons of economies of scale, may contract with a Warehouse 110b in that local community to store or warehouse their merchandise or inventory that is for sale to residents of that local community. Such situations, it may be desirable for the Warehouse 110b to commit to make a donation to an Affinity Entity 112, selected by the Community Resident 110a, whenever the Community Resident 110a conducts a transaction with a merchant in the local community, where the merchandise purchased in the transaction is picked up by Delivery Service 110c from Warehouse 110b in the local community for delivery as a packaged purchase 110d to the home or place of business of Community Resident 110a in the local community. Each such donation by Warehouse 110b will serve as an incentive to Community Resident 110a to do business with each merchant in the local community, while also stimulating the rotation of each merchants' inventory in Warehouse 110b, and increasing donations to Affinity Entities 112 (e.g., charities and service organizations) in the local community.

Web Service 100 retains the derived donation for subsequent audit purposes to ensure compliance by each donor in its donation commitments to each of the one or more Affinity Entities 122. The Web Service 100 may transmit a message containing a notice of a donation, or the particularly derived donation, as shown at reference numerals 118-120 to respective logical addresses of the obligated donors. Each donor can be one or more of the merchant, the Community Resident 110, the issuer 114, the acquirer 113, the transaction handler for the issuer 114 and acquirer 113, the Warehouse 110b, and/or the Delivery Service 110c. Each donation by each donor is made to one or more Affinity Entities 122. The terms and conditions that obligate the donor to make a donation may, but need not, include discounts, rebates, or other monetary or non-monetary incentives. As such, the Community Resident 110a is incentivized to make purchase from the Merchant's e-Commerce Website 106 for delivery to the residence or business of the Community Resident 110a by at least by the one or more donors' agreements to donate to one or more Affinity Entities 122 that were selected by the Community Resident 110a.

Each Affinity Entity 122, which may be selected at the discretion of the Community Resident 110a, may be any entity to which the Community Resident 110a has an affinity, regardless of where it is located or whom it serves. Alternatively, the Affinity Entity 122 may be limited to those organizations that provide a good and/or service to a community in which both the Community Resident 110a and merchants transacting with the Community Resident 110a have an affinity—such as by their common geographic location. By way of example, and not by way of limitation, the Affinity Entity 122 may provide food and clothing to needy families in a community that is common to both the Community Resident 110a and merchants transacting with the Community Resident 110a. The Affinity Entity 122, for example, may provide teaching and demonstrations of entrepreneurial skills to community's unemployed or under employed. Another Affinity Entity 122 may provide venues where sports education can be provided to local competing youth. Yet another Affinity Entity 122 may provide care and feeding to abandoned domesticated animals, such as pets. The Affinity Entity 122 may also cultivate desirable citizenship and public policy through offerings of education and entertainment services—whether in person, on-line, or both. Given the foregoing, the reader will understand that the Affinity Entity 122 can be either a for-profit or a non-profit organization, and may optionally be required to provide a good or a service to a local community in which both merchants and their customers are located, do business, or have their place of residence. By making donations to organizations that are located within the same community of both the merchant and the Community Resident 110a, this incentive to purchase has a positive effect on the common location so as to advance and/or promote the community.

In some alternative implementations, each donor will designate and communicate to the Community Resident 110a the Affinity Entity 122 to whom the donor will make a donation. To identify the Affinity Entity 122, a customer identifier, as received by Web Service 100 in message 116, will look up the community where the customer resides and where the merchant-offer has a brick and mortar store. Web Service 100 uses information in or derived from message 116 to determine whether the merchant and its transacting Community Resident 110a have the same local community. By way of example, data in message 116 can include an identifier for the Community Resident 110a, and a database of merchants and their respective merchant-offers can include geographic location information. This geographic location information is matched against the geographic location information for the residence of the Community Resident 110a. Merchant and customer identifiers can be assigned to the merchant and its transacting Community Resident 110a during or prior to any transaction, such as when each are registered with or otherwise sign up for participation with Web Service 100. This registration process can include the collection of physical and logical addresses for each or for their respective agents.

Once physical address information for the merchant-offeror and its transacting Community Resident 110a are known, the local community of each of the merchant and its transacting Community Resident 110a can be determined—in some implementations. The local community determination can be made on any of several different methods, or combinations thereof. Once such method is a political or legal division, that is, the merchant's place of business is determined to be in the same political or legal division as that of its transacting Community Resident 110a's residence, such as the same province, state, county, prefecture, city, city-state, borough, etc. Another such comparison can be whether the merchant's place of business has a governmentally issued postal code that is the same, or within a predetermined proximity, as that of its transacting Community Resident 110a's residence.

Yet another such comparison can be whether the merchant's place of business and that of its transacting Community Resident 110a's residence are physically proximate within a predetermined factor by any of a variety of measures or combinations thereof. For example, latitude and longitude coordinates might be known for both the merchant's place of business and the residence of its transacting Community Resident 110a. These coordinates can be used to determine whether the linear distance there between is within a predetermined distance to ascertain whether or not the merchant and its transacting Community Resident 110a's residence share the same local community.

Alternatively, a navigation algorithm may use navigation data from online mapping data bases applicable to any of various different travel methods (e.g., walking, automobile, bicycle, mass transit, etc.), and can be used to determine whether the time, using one or more travel methods, is within a predetermined time limit to ascertain whether or not the merchant and its transacting Community Resident 110a's residence share the same local community or ‘neighborhood’. By way of example, the merchant and its transacting Community Resident 110a's residence might be determined to be within the same local community if the automobile drive time, as determined from one or more databases of contemporary cartographic road system information, to navigate between the merchant's brick and mortar store and the transacting Community Resident 110a's residence is less than a predetermined time threshold (e.g., 17 minutes).

A further alternative implementation will identify the population density of both the merchant's brick and mortar store and the transacting Community Resident 110a's residence. If the population density exceeds a predetermined density, then the merchant and the transacting Community Resident 110a might be determined to be within the same local community if the time to walk, bicycle or take public transportation between the merchant's brick and mortar store and the transacting Community Resident 110a residence, as determined from one or more databases of contemporary topographic, mass transit, and/or pedestrian cartographic system information, is less than a predetermined time threshold (e.g., 55 minutes). Such implementations may also access databases to consider real time traffic conditions.

Still another such comparison can be whether the merchant's place of business and its transacting Community Resident 110a's residence are proximate or are the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its transacting Community Resident 110a, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

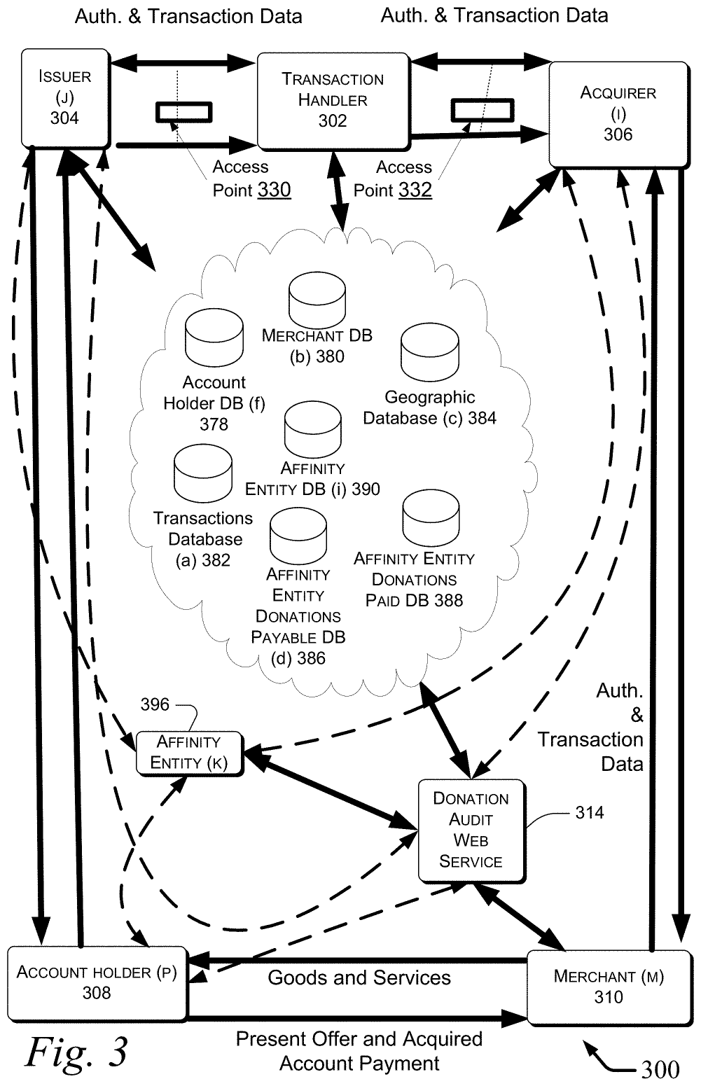

Similar or different algorithms that are used to determine the respective local community of the merchant and its transacting Community Resident 110a can also be used to determine the local community of an Affinity Entity 122, or as that shown as an Affinity Entity (k) 396 in FIG. 3, as discussed herein below.

In some implementations, if the local community of the merchant, its transacting Community Resident 110a, and an Affinity Entity 122 that has been selected by the transacting Community Resident 110a or by other methods are the same, then the business rule selected by the merchant will determine the amount of the donation that the merchant will make to the selected Affinity Entity 122. In some implementations, the Affinity Entity 122 to whom a merchant is to make a donation can only be selected the transacting Community Resident 110a, and not the merchant. In such implementations, the goals or purposes of an Affinity Entity 122 will not cause tension between merchant and its transacting Community Resident 110a in that the identity of the Affinity Entity 122 is unknown to the merchant though being selected anonymously by its transacting Community Resident 110a. As such, the merchant need not be told or be given any notice, directly or indirectly, as to the identity of the Affinity Entity 122 selected the Community Resident 110a with whom the merchant is conducting a transaction. Rather, the merchant might only be told or be given notice to make a single payment of, or period payments to, a single Affinity Entity 122 who, as trustee or agent, will thereafter make respective disbursements for all registered merchants (and other such donors) accordingly to those Affinity Entities 122 that had been selected those Community Residents 110a with whom those merchants had conducted transactions. Each other donor, as referred to above, may also be precluded from being told or given any notice, directly or indirectly, as to the identity of the Affinity Entity 122 selected the Community Resident 110a.

Various implementations can ensure that a merchant (or other donor) who, by force of reason or conscience, does not want to make a donation to a particular Affinity Entity 122, need not do so directly, as any and all merchant donations are made blindly through other avenues or collection points that make all donation disbursements to all Affinity Entities 122. Accordingly, each merchant, or other donor, will have notice of its total periodic donations without knowing the identity of the intended recipients, thereby leaving the direction of donations fully within the discretion of each Community Resident 110a. Note that a limitation can be optionally placed upon the Community Resident 110a's choice of Affinity Entities 122 such that the choice must be made only among those Affinity Entities 122 that serve the local community of the merchant, its transacting Community Resident 110a, or both. Such implementations may leave the currency amount of the donor's donation fully within the discretion of the donor (e.g., the Community Resident 110, the issuer 114, the acquirer 113, the transaction handler for the issuer 114 and acquirer 113, the Warehouse 110b, and/or the Delivery Service 110c).

Web Service 100 can use respective identifiers for the merchant and its transacting Community Resident 110a (e.g., account holder) to access and retrieve geographic information for each, and then apply an algorithm to the retrieved geographic information to determine the respective local communities of the merchant and its transacting Community Resident 110a, as discussed above. By way of example, the local community can be progressively granular in nature, such as: 1^{st} the United States of America; 2^{nd} the state of New York; 3^{rd} the portion of New York called “Long Island”; 4^{th} the county of Nassau within the state of New York; 5^{th} a portion of the Nassau County called North Hempstead; and then 6^{th} the specific geographic location of “Port Washington”. This final level of geographic granularity indicates a community in which both merchant and transacting Community Resident 110a are members, neighbors, residents, and/or the like.

Yet another level of geographic granularity can be used to perform a look-up against one or more databases to which Web Service 100 has access. This access and lookup is used by Web Service 100 to identify: (i) the Affinity Entity 122 for that community which, in this example, might be the Port Washington Food Bank located in Port Washington, N.Y., which the Affinity Entity 122 might have been specified by the transacting Community Resident 110a; and (ii) the respective identifier of the merchant's business rule (and/or another donor's business rule) that is to be used to make a calculation of the currency amount of the donation that the donor is to make to the Affinity Entity 122 for that community. Business rule(s) is/are used with the currency amount of the transacting Community Resident 110a's payment in order to calculate the currency amount of the donation that is to be made by each donor to the Affinity Entity 122 for that community. Note that the donation can be directed to a plurality of Affinity Entities 122 for the local community according to directions that had been previously specified by transacting Community Resident 110a. For example, the transacting Community Resident 110a may have specified that each donor's donation is to be split evenly, or in specified portions totaling one hundred percent (100%), between five (5) local community Affinity Entities 1222, for example: (i) a local youth sports team cooperative; (ii) a local charter junior high school; (iii) a local house of worship; (iv) a local political party; and (v) a local for-profit college specializing business entrepreneurialism.

Referring now to FIG. 1, the Community Resident 110a can use the conditional offer 102 to conduct an e-commerce transaction with a merchant via its Merchant e-Commerce Website 106. The Community Resident 110a conducts the transaction on an account 104 issued by an issuer 114 to the Community Resident 110a to pay for the transaction and buy the purchase that is to be received as a Packaged Purchase 100d from the Warehouse 110b via the Delivery Service 110d.

In some implementations, the donor's obligation to donate may be to make a donation of a certain percentage of the entire currency amount of the transaction, or the offer may obligate the donor to make a donation only if the transaction is conducted at a certain time of day or on a particular day of the week, or only if the currency amount of the transaction exceeds a predetermined amount, or a combination of the foregoing.

Although some terms of the offer to donate may differ from some terms of subsequent transactions between the merchant and its transacting Community Resident 110a, nevertheless, each donor's offer to make a donation to an Affinity Entity 122 fundamentally provides an incentive that causes, at least in part, the local Community Resident 110a to navigate to the local merchant's e-Commerce Website 106, shop, and ultimately conduct an e-commerce transaction that will bring revenue to the local merchant and its community. Advantageously, the absence of specificity in the offer as to a particular good or service allows many implementations to operate without modification to the merchant's input of data about the transaction at the local merchant's e-Commerce Website 106.

Optionally, a Community Resident 110a (e.g., customer) may accept the offer to donate 102 from the donor in advance of going to the local merchant's e-Commerce Website 106. Such advance acceptance may take place electronically, such as in response to the Community Resident 110a's electronic receipt of offer 102. Such an electronic acceptance to offer 102 can be by way of a transmission of information from the Community Resident 110a from the merchant, the issuer 114, the acquirer 113, the transaction handler of the Payment Processing Network 112 handling the transaction for the issuer 114 and the acquirer 113, the Warehouse 110b, and/or the Delivery Service 110c. The transmitted information can include: (i) an identifier for the Community Resident 110a who intends to accept the offer 102; (ii) the calculated distance and/or time for the Community Resident 110a to navigate from a geographic location associated with the Community Resident 110a (e.g., home location, work location, vacation location, etc.) to the merchant's physical and/or brick and mortar store by walking, bicycling, automobile and/or mass transit; (iii) the terms and conditions of the offer 102 including any expiration thereof; (iv) optionally any other information already conveyed to the Community Resident 110a, such as a statement about the donation that each donor will will make to the Affinity Entity(ies) 122 when the Community Resident 110a conducts a timely e-Commerce transaction with the merchant via the Merchant's e-Commerce Website 106; (v) the date by which the Delivery Service 110c will make a delivery of the Packaged Purchase 110d to the Community Resident 110a; and (vi) other unexpired offers or advertisements that may or may not have been conveyed to the Community Resident 110a, terms and conditions of such other offer(s), etc.

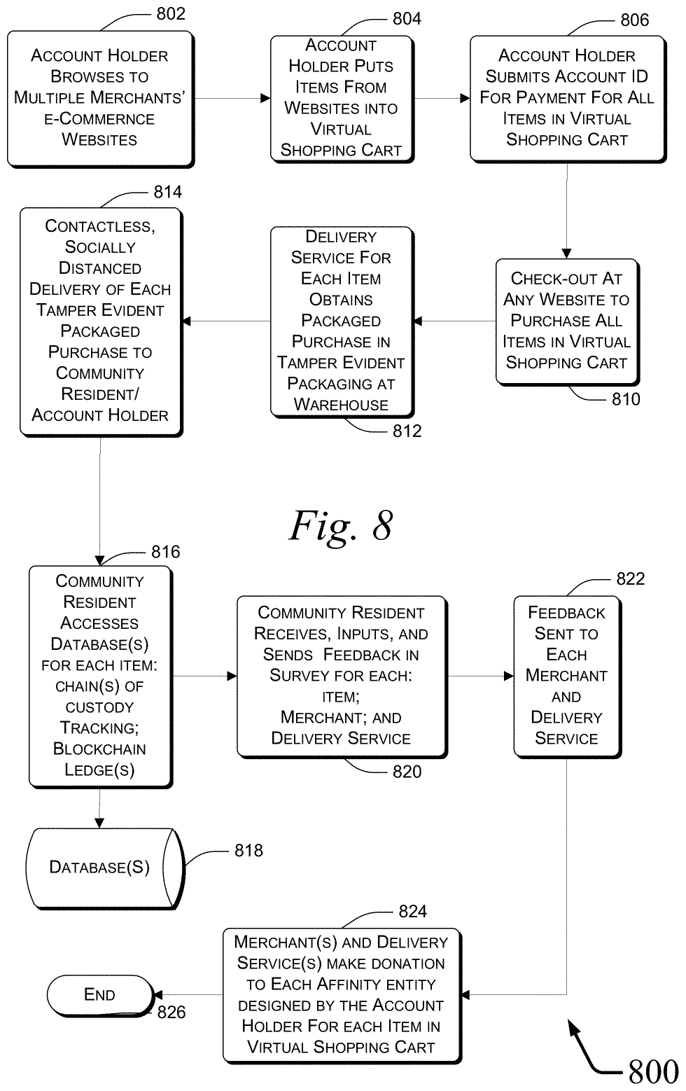

Referring to FIGS. 1 and 8, a flowchart in FIG. 8 illustrates a Process 800 that can be performed by a system, such as a system including Web Service 100 in FIG. 1 and/or Donation Audit Web Service 314 seen in FIG. 3, for using donors' commitments to make contributions to Affinity Entities 122 as incentives to Community Residents 110a to conduct transactions with local merchants. At step 802 of Process 800, an account holder uses a client, whether a thick client or a thin client, to browse multiple merchant's e-Commerce websites. At step 804, the account holder puts items from one or more of the merchant's e-Commerce websites into a virtual shopping cart. At step 806, the account holder submits an identification for an account upon which one or more transactions are to be conducted with one or more of the merchants corresponding to the multiple merchant's e-Commerce websites in order to pay for each of the items in the virtual shopping cart. At step 810, the account holder conducts a check out at any of the e-Commerce websites so as to pay for each of the items in the virtual shopping cart using the identified account (e.g., debit account, revolving credit account, prepaid account, gift account, etc.)

At step 812, a delivery service takes physical custody of an item representing each item in the virtual shopping cart, such as from a warehouse. Preferably, each item will be contained within a package that has tamper evident package. At step 814, each delivery service with physical custody of the packaged purchase in the tamper evident packaging facilitates delivery and transfer of physical custody of the packaged purchase to the account holder who is a community resident. Preferably, the delivery service will transfer physical custody of the packaged purchase to the community resident in manner that is both contactless and socially distanced. Preferably, the community resident will have at least one of a place of resident and a place of business in a community where each merchant from whom an item was purchased has a physical place of business (e.g., a brick and mortar store or business location).

After the community resident accepts delivery and physical custody of the packaged purchase, at step 816, the community resident can access one or more databases 818, preferably via an network such as the internet. Each of the one or more databases 818 contains information about each item in each packaged purchase that was delivered by each delivery service as a result of each merchant selling the item that was purchased. Preferably, this information will include chain of custody and blockchain ledger data for each item. Access to, and review of, this information will preferably be sufficient to allow the community resident to make a quality assessment with respect to each purchased item, each delivery service, and each merchant from whom each item was purchased.

At step 820, the community resident receives a survey from which feedback from the community resident can be input as to each quality assessment of each purchased item and for each delivery service. At step 822, the feedback from the survey(s) of the community resident are sent to the corresponding merchants from whom items were purchases, and to the corresponding delivery services that transferred physical custody of each item in each packaged purchase to the community resident. At step 824, a merchant and delivery service defined donation is made by each merchant and delivery service, respectively, to each affinity entity designated by the community resident for each item that was purchased from each merchant. In other implementations, a donation to the affinity entity designated by the community resident can also be made, and defined, by each issuer of the account used by the community resident to make the purchase, each acquirer for each merchant, the transaction handler for each issuer and each acquirer, and the warehouse from which the delivery service retrieved the packaged purchase to be delivered to the community resident. Process 800 then terminates at step 826.

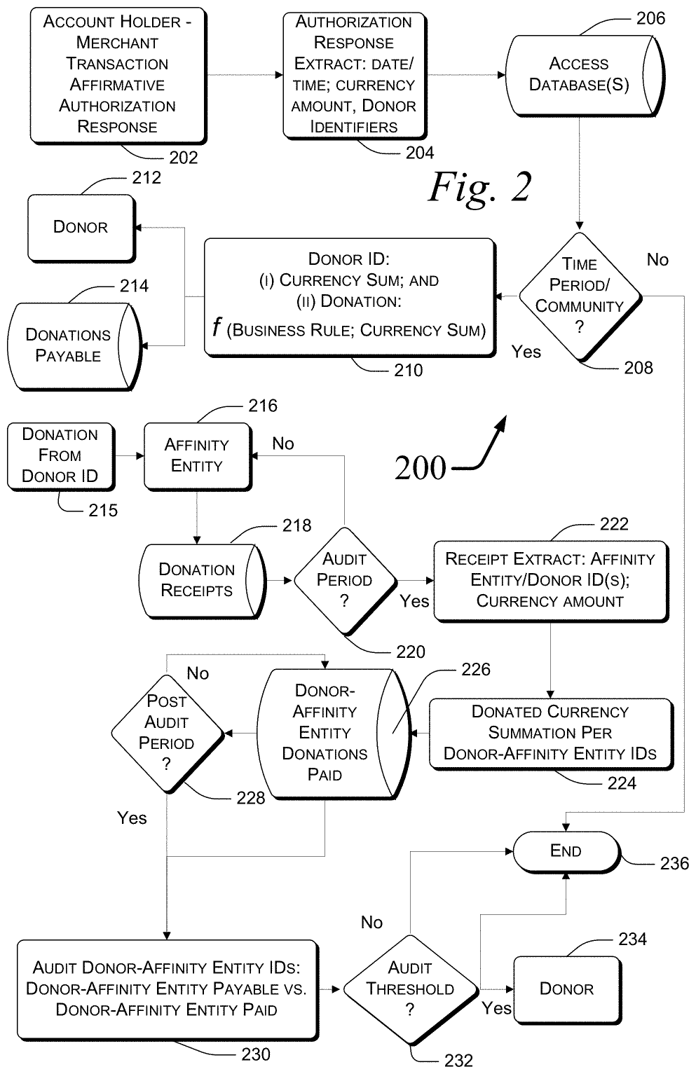

Referring to FIGS. 1-3, a flowchart in FIG. 2 illustrates a Process 200 that can be performed by a system, such as a system including Web Service 100 in FIG. 1 and/or Donation Audit Web Service 314 seen in FIG. 3, for using donors' commitments to make contributions to Affinity Entities 122 as incentives to Community Residents 110a to conduct transactions with local merchants. Prior to step 202 of Process 200, as discussed above with respect to FIG. 1, a local Community Resident 110a conducts a transaction on an account issued to the local Community Resident 110a at a Merchant e-Commerce Website 106 of a local community merchant. Prior to this transaction, as discussed above with respect to FIG. 1, the registered local Community Resident 110a may receive one or more such offers 102, either passively and/or actively by request.

At step 202 of FIG. 2, information is received as derived from a positive authorization response originating from an issuer 114 of an account, or its agent, upon which the transaction was conducted by the Community Resident 110a with the merchant as describe above with respect to FIG. 1. Data from this information can be extracted at step 204 by a Merchant e-Commerce Website 106 seen in FIG. 1, including, by way of example and not by way of limitation, the date and time of the transaction, a total currency amount to be paid to the merchant at clearing and settlement on the Community Resident 110a's account, respective identifiers for the merchant and Community Resident 110a, etc.

Identifiers retrieved at steps 202-204 can be used to access one or more databases at step 206. The date and time for the transaction can be compared to ensure the non-expiration of the offer made by the merchant to the Community Resident 110a in a query at step 208. While an invalid offer determination ends Process 200 at step 236, Process 200 proceeds to step 210 when the offer is valid as determined at query 208.

At step 210, rules are applied for calculating each donation that is be made by each donor for each of the one or more Affinity Entities 122 via retrieval of information using data acquired in steps 202-204. These calculations can include steps to access one or more databases as shown at reference numerals 212-214, including transmitting to and/or storing the calculated donations in one or more donor databases 212 and/or in one or more donations payable databases 214.

Subsequent to the acquired transaction on the Community Resident 110a's account as processed in steps 202-214 of Process 200, each of the one or more donors (the Community Resident 110a, the merchant, the issuer 114, the acquirer 113, the transaction handler of the Payment Processing Network 112 handling the transaction for the issuer 114 and the acquirer 113, the Warehouse 110b, and the Delivery Service 110c) makes the calculated donation to the local Affinity Entity 122 as shown at step 215. The local Affinity Entity 122, as shown at step 216, sends notice of the donation's receipt for storage in one or more databases as shown at step 218.

After a predetermined audit time period as passed as determined by a query at step 220, an audit is conducted to ensure compliance by each donor with respect to its donation commitments to each of the one or more Affinity Entities 122 for which prior notice of such donations were provided to the donor. This audit can include adding up all required donations for each donor to each Affinity Entity 122 as shown at step 222. The donation summation for each donor to each Affinity Entity 122 at step 224 is compared to information in one or more databases 226 to ascertain compliance of each donor with respect to the donation obligation criteria that the donor had previously defined. Stated otherwise, the donor has a certain amount of time after a predetermined audit period, as determined at step 228, by which to complete or make all of the donor's donation obligations to all Affinity Entities 122.

Differences between donations paid and donations still payable by each donor are calculated at step 230, which differences are subjected to an audit threshold query at step 232. If the sum total of a donor's donations that have been paid is non-compliant with donations still payable, as may be determined by the audit threshold query at step 232, then Process 200 moves to step 234 to notify the donor, or its agent, accordingly of its deficiency. Otherwise, affirmative results at query 232 causes Process 200 to terminate at step 236 which may also include notice of compliance being transmitted to each such complaint donor, the corresponding transacting Community Residents 110a, and/or each of the Affinity Entities 122. Each such notice can be either by way of summary report, donations to respective a Affinity Entities 122 by the corresponding donor, and variations thereof. Note also that progressive summaries of donations can be widely broadcast periodically incident to fundraising campaigns, capital development initiatives, periods of national crisis, and times of community need, thereby providing social motivation and incentives to an entire community of participating shoppers to help charities simply by purchasing from participating local community merchants.

In other implementations, Process 200 includes the exaction of data from information derived incident to a positive authorization response for an acquired transaction conducted on a Community Resident 110a's account, such as chronological information pertaining to the transaction including date and time, a currency amount of the transaction, and any other data desired to assist in a proper calculation of each donor's obligatory to a make a donation to Affinity Entity as shown in Process 200 of FIG. 2 at reference numeral 216. By way of example, an identifier for the merchant can be extracted, as well as an identifier for the local Community Resident 110a as offered to the merchant by the same. The account number, by way of non-limiting example, can be a Primary Account Number (PAN) including a Bank Identifier Number (BIN) for a credit or debit card that is kept by the merchant in a ‘ card-on-file’ database.

Note that, in various implementations, business rules can be set and used such that obligatory donations to Affinity Entity(ies) 216 can be made by one or more of the following participants in a payment processing system: the Community Resident 110a, the issuer 114, the merchant, the acquirer 113, the transaction handler for the Payment Processing System 112, the Warehouse 110b, and the Delivery Service 110c. Via access to one or more databases at step 206, and by using the merchant and/or Community Resident 110a identifiers extracted from the information derived from the positive authorization response, more information can be retrieved. Thereafter, database access can retrieve business rules used to calculate one or more donations that are to be made to the Affinity Entities 122 by one or more donors respectively corresponding to the Community Resident 110a, the issuer 114, the merchant, the Delivery Service 110c, the merchant's acquirer 113, the transaction handler for the Payment Processing Network 112, the Warehouse 110b, and the Delivery Service 110c. Each such donation can be a function of the currency amount of the transaction and the retrieved business rule(s).

In some implementations, donations, per extracted donor IDentifier (ID), are made for those transactions that occur during a predetermined time-period and, optionally, within a predefined geographic location as determined by a query (not shown). If the result regarding a community, geography, or neighborhood query is affirmative, process 200 moves to step 210 where the donations that are to be made by the donor participants in the payment processing system are calculated as a function of the respective business rules. Otherwise, no donation is made and process 200 terminates at step 236. Stated otherwise, in such implementations, Process 200 is intended to obligate a donor to make a donation to a local Affinity Entity 122 when a Community Resident 110a conducts a transaction at the local merchant's e-Commerce Website 106, where the merchant has a physical location (e.g., a brick and mortar retail store) in the same community where the Community Resident 110a resides. Note that the terms ‘ local’, ‘ resident’, ‘ residential’, ‘ community’, neighborhood, and the like, can be alternatively defined as described elsewhere herein.

As in other implementations described above, donations calculated at step 210 are communicated to the donor, or its agent, at step 212, and are stored in a donations payable database 214. Thereafter, donations 215 are received at Affinity Entities 216 at step 215 from donors identified by either respective donor IDs, which can be the identifier for the merchant or for other payment processing system participants, including the Delivery Service 110c. Donations received are stored in donation receipts database 218. Data from donations that are made by donors via communication to Affinity Entities 216 during an audit period, as determined at query 220, is extracted at step 222. The donation-related data that is extracted at step 222 can include the donor ID, and the currency amount of the donation. During the audit period, a sum of donations to each Affinity Entity 216 made by each donor for the audit period is calculated and stored in a donor-Affinity Entity donation paid database 226. After a predetermined time period, an audit period begins, as determined by query 228. During the audit time period, differences in donations paid are compared to donations payable for each donor at step 230. Differences exceeding a predetermined audit threshold, as determined by query 232, are communicated to the respective donors, or their respective agents, at step 234. Of course, the charitable audit functions, such as have been described above, can be performed by an agent of any donor and/or of a loyalty system organization charged with implementing all or portions of process 200. Such an auditing agent can be, by way of non-limiting example, a certified public accountancy agency, a non-government regulatory agency, a governmental agency, and the like.

As further discussed above with respect to various implementations, a donation mechanism can be set up such that the donor makes blind donations, either directly or indirectly, to a single donation disbursement entity who in turn disburses the donations to those Affinity Entities 122 selected by the Community Residents 110a. This donation mechanism provides neither knowledge nor notice to donor as to the identities of its donation recipients, thereby avoiding circumstances that force the donor, by virtue of its prior commitment, to donate to a local community Affinity Entity 122 whose role or purpose is inimical or otherwise repugnant to the donor. As such, the donation mechanism leaves the direction of the donor's donation fully within the discretion of the Community Resident 110a, limited only, in some implementations, by the restriction that the Community Resident 110a can only select from among those Affinity Entities 122 that serve the local community that is in common to both the Community Resident 110a and the merchant, while leaving the actual currency amount of the donation fully within the discretion of each donor.

Referring now to FIGS. 1-3, an exemplary process 300 is depicted of a particular financial transaction system, such as may be described as an open loop system, in which an Account Holder (p) 308 conducts an e-Commerce financial transaction with a Merchant (m) 310 for a purchase that is to be picked up at a Warehouse 110b for delivery to the account holder (p) 308 by a Delivery Service 110c. By way of example, the Account Holder (p) 308's financial transaction with the Merchant (m) 310 may have been incentivized by one or more donors' agreement to make a donation to an Affinity Entity (k) 395 in the local community as defined by the donor by way of an ad incentive which, optionally, can be communicated to Account Holder (p) 308, whether requested or not. The donor can be one or more of the Issuer (j) 304, the Transaction Handler 302, the Acquirer (i) 306, the Warehouse 110b, the Delivery Service 110c, and/or the Merchant (m) 310. The Account Holder (p) 308, can also commit to making a donation. As such, a donation can be made by to Affinity Entity (k) 395 in the local community by at least one donor and up to seven (7) different donors.

In FIG. 3, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘ (b)’ is intended to mean that the integer ‘ b’ can have a value from 1 to B, and ‘ (c)’ is intended to mean that the integer ‘ c’ can have a value from 1 to C, etc. As such, drawing elements 304-310 and 378-390, and 396 in FIG. 3 are illustrated with a block, but indicate one or more elements can be present. For example, Issuer (j) 304 is one of a possible plurality of issuers, where j may range from 1 to a large integer ‘J’.

Account Holder (p) 308 presents, virtually, an identified for a payment device (i.e.; a credit or debit card) to a Merchant (m) 310 via the Merchant's e-Commerce Website 106 as tender for a financial transaction such as a purchase of goods and services. As part of the transaction, the Account Holder (p)'s 308 payment device can be a credit card, debit card, prepaid card, cellular telephone, Personal Digital Assistant (PDA), etc. Those of skill in the art will recognize that other financial transactions and instruments other than credit cards may also be used, including, but not limited to, a prepaid card, a gift card, a debit card, a token equivalent of an account as communicated via cellular telephony, near field communications, and the like. For purposes of illustration and explanation, however, reference will be made to a credit card.

Data for the payment device included account information communicated to via a request for authorization that is transmitted to the Merchant (m) 310's Acquirer (i) 306. Each Acquirer (i) 306 is a financial organization that processes credit and/or debit account or card transactions for businesses, for example merchants, and is licensed as a member of a Transaction Handler 302 such as a credit card association (i.e., Visa Inc., MasterCard, etc.) As such, each Acquirer (i) 306 establishes a financial relationship with one or more Merchants (n) 310. In some closed loop systems, a payment system participant may serve in multiple roles, such as where the payment system participant is issuer, acquirer, and transaction handler (i.e., Discover Card, American Express).

The Acquirer (i) 306 transmits the account information to the Transaction Handler 302, who in turn routes the authorization request to the Account Holder (p) 308's issuing bank, or Issuer (j) 304. The Issuer (j) 304 returns information via an authorization response to the Transaction Handler 302 who returns the information to the Merchant (m) 310 through the Acquirer (i) 306. The Merchant (m) 310, now knowing whether the Account Holder (p) 308's credit card account is valid and supports a sufficient credit balance, may complete the transaction and the Account holder (p) 308 in turn receives goods and/or services in exchange.

To reconcile the financial transactions and provide for remuneration, information about the transaction is provided by the Merchant (m) 310 to Acquirer (i) 306, who in turn routes the transaction data to the Transaction Handler 302 who then provides the transaction data to the appropriate Issuer (j) 304. The Issuer (j) 304 then provides funding for the transaction to the Transaction Handler 302 through a settlement bank. The funds are then forwarded to the Merchant's (n) 310 Acquirer (i) 306 who in turn pays the Merchant (m) 310 for the transaction conducted at step 362 less a merchant discount, if applicable. The Issuer (j) 304 then bills the Account holder (p) 308, and the Account holder (p) 308 pays the Issuer 304 with possible interest or fees.

Also shown in FIG. 3 are one or more Affinity Entities (k) 396 and a Donation Audit Web Service 314 that implementations processes by which donations to the one or more Affinity Entities (k) 396 from various donors, for instance, any Issuer (j) 304, an Merchant (m) 310, any Acquirer (i) 306, the Transaction Handler 302, the Warehouse 110b, and the Delivery Service 110c. Donation Audit Web Service 314 implementations processes for the auditing of donations from each donor to the one or more Affinity Entities (k) 396. The Donation Audit Web Service 314 has access to information resources within the following databases: Account Holder DBs 378; Merchant DBs 380; Transaction Databases 382; Geographic Databases 384; Affinity Entity Donations Payable 386; Affinity Entity Donations Paid 388; and Affinity Entity Database 390.

By way of example, and not by way of limitation, construction of local, geographic, residential or community associations between merchants and their customers can include factors such as geographic, political, demographics, local transportation modes, navigational algorithms for geopolitical regions, cartographic data, planned communities, population density, cultural divides, racial population constituencies, census statistics, socio-economic factors, and combinations thereof.

As shown in FIG. 3, Databases 378-790 can be connected by one or more private or public networks, virtual private networks, the Internet, or by other means known to those skilled in the art. Moreover, not every entity seen in FIG. 3 at reference numerals 308, 310, 396 and 394 must necessarily have real time, uninterrupted access to any or all of the Databases 378-390. Each such Database 378-390 can assign, read, write, and query permissions as appropriate to the various entities. For example, a Merchant (m) 310 may have read access to the one or more Transactions Databases 382.

Each Transactions Database (a) 382 can be designed to store some or all of the transaction data originating at the Merchants (n) 310 that use a payment device for each transaction conducted between an Account holder (p) 308 and the Merchant (m) 310. The transaction data can include information associated with the account of an Account holder (p) 308, date, time, and an identifier sufficient to determine a physical geographic location attributable to customer and merchant, among other more specific information including the amount of the transaction. The database can be searched using account information, date and time (or within proximity thereof), or by any other field stored in the database.

The Transactions Database (a) 382 is also designed to store information about each Merchant (m) 310, where the information can include a unique identification of each Merchant (m) 310, an identifier for each point of sale device in use by the Merchant (m) 310, and a physical geographic location of each store of the Merchant (m) 310.

Also included in the Transactions Database (a) 382 is account information for payment devices associated with Account holder (p) 308, such as part or all of an account number, unique encryption key, account information, and account name of an account holder who is registered to participate in a system in which donations can be made to each Affinity Entity (k) 390 as per rules stored in Merchant Database (b) 380. After registering to participate in the donation system, an Account holder (p) 308 initiates a qualifying purchase transaction with a Merchant (m) 310 by electronically or virtually presenting a payment device (not shown) to the Merchant (m) 310 via the Merchant's e-Commerce Website 106. Certain transaction information is transmitted from the Merchant's e-Commerce Website 106 in route to the Merchant's (n) 310 Acquirer (i) 306. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (m) 310, and the ultimate destination, such as the Acquirer (i) 306. These points can include, without limitation, from the Merchant's e-Commerce Website 106 for the Merchant (m) 310 and a network router or computer that is connected to a network but is housed and maintained by the Merchant (m) 310 and between the Merchant (m) 310 and the Acquirer (i) 306. The communication channel could be Ethernet, wireless internet, satellite, infrared transmission, or other known communication protocols. Some or all of the transmission may also be stored for record keeping, archival or data mining purposes with little or no encryption. For example, the Merchant (m) 310 may store transaction data, including certain account information in the Merchant's (n) 310 accounts on file database for reuse later.

During a transaction conducted by Merchant (m) 306 on an account issued by Issuer (j) 304 to Account Holder (p) 308, information relating to the qualifying purchase is retrieved from the Merchant's e-Commerce Website 106 for the Merchant (m) 306. The transaction information is comprised of account information together with other information about the transaction itself: time, date, location, value, etc. Certain of the transaction information are considered sensitive information including, without limitation, account number, credit card verification number, and account name.

For the Account Holder (p) 308 to donate to each Affinity Entity (k) 396 as may have been previously specified, the Account Holder (p) 308's Issuer (j) 304 can pay the Affinity Entity (k) 386 and apply a debit in that currency amount on the Account Holder (p) 308's periodic revolving credit statement. The Account Holder (p) 308, upon receipt of the statement, can thereafter make a total payment to the Issuer (j) 304 of the currency amount of the donation that appears as a debit on the statement along with the other credit charges that also appear on the Account Holder (p) 308's statement.

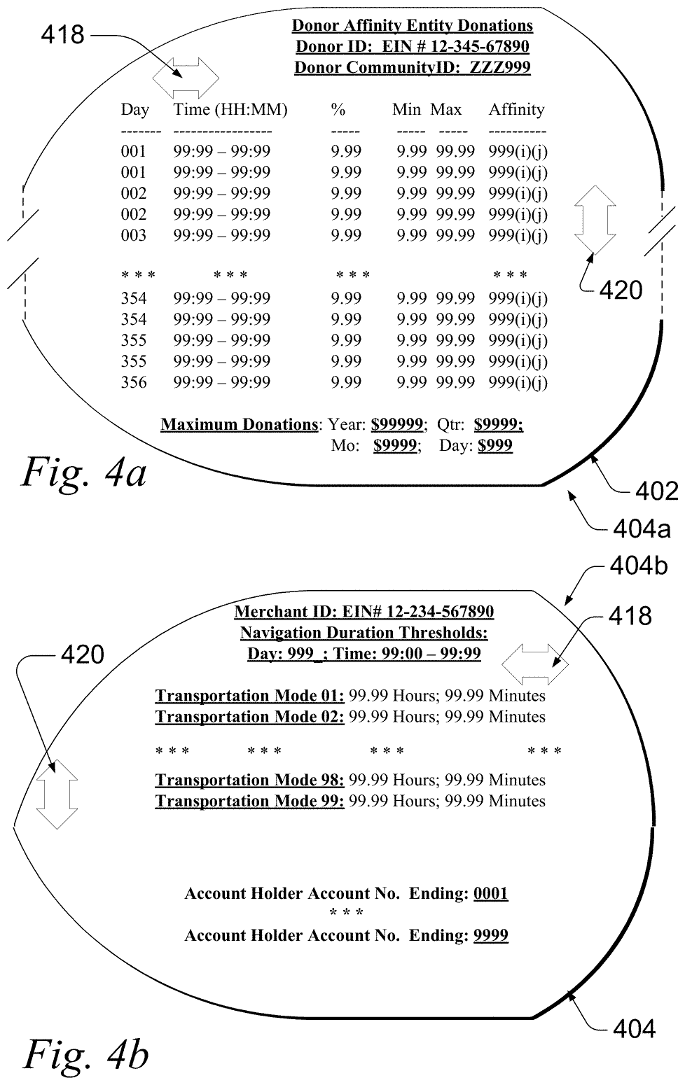

As discussed below with respect to FIGS. 4 a through 5b, each donor, including the Account Holder (p) 308, the Merchant (m) 310, the Issuer (j) 304, the Transaction Handler 302, the Acquirer (i) 306, the Warehouse 110b, and the Delivery Service 110c, can change or disable the criterial for making a donation commitment at any time by accessing a server that serves web pages where respective user interfaces are provided. Thus, donation commitments can be enabled or disabled using real time user interfaces. By way of example, and not by way of limitation, such servers can be hosted by the Donation Audit Web Service 314 seen in FIG. 3.

In various implementations, Donation Audit Web Service 314 seen in FIG. 3 receives information that confirms such a timely transaction between the Account Holder (p) 308 and the Merchant (m) 310 by way of receiving information derived from an authorization response for the transaction. As more fully described elsewhere herein with respect to FIG. 3, the information in the authorization response is typically generated by an Issuer (j) 304 who issued an account to the Account Holder (p) 308 (e.g., the client of the Account Holder (p) 308) on which the timely e-Commerce transaction with the Merchant (m) 310 was conducted. A positive authorization response reflects the Issuer (j) 304's approval of the transaction on the account issued to Account Holder (p) 308. Stated otherwise, and as shown in FIG. 3 and discussion herein below, Donation Audit Web Service 314 receives the information derived from an authorization response from an acquired account payment processing system (i.e., see Ref. Num. 105 in FIG. 1), where each of the Issuer (j) 304, the Account Holder (p) 308, and the Merchant (m) 310 operate in the acquired account payment processing system.

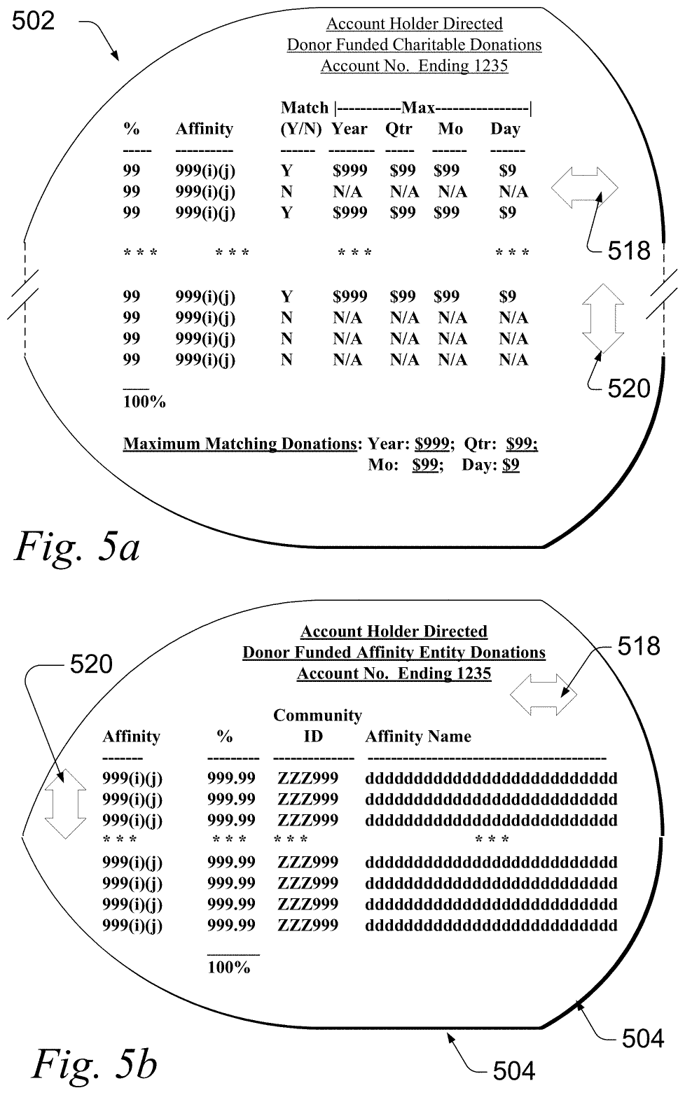

Once confirmation has been received by Donation Audit Web Service 314 that a timely transaction has taken place been the Merchant (m) 310 and the Account Holder (p) 308, a calculation is made of an amount of a donation that each donor is to make according to terms of an offer to the Account Holder (p) 308. By way of example, the terms of the offer to make the donation to the Affinity Entity 396 may have been previously input for storage in Merchant DBs 380 by way of the merchant's user interface provided by an application executing on a computing device, such as in conjunction with a screen shots 402-404 seen in FIGS. 4a-4b as described herein below. To give notice of the donation obligation that has arisen, the calculated donation can be sent in one or more transmissions from Donation Audit Web Service 314 to one or more logical addresses such as: (i) the Merchant (m) 310; (ii) the Affinity Entity 396; (iii) the Customer or Account Holder (p) 308—or to respective agents thereof. Optionally, information that identifies the Affinity Entity 396; and/or (iii) the Account Holder (p) 308 can be included in any such transmission.

Where the Affinity Entity 306 to which a donor is obligated by the timely transaction to make a donation is specified by the Account Holder (p) 308 (e.g., such as by use of a user interface having a screen shots 502-504 seen in FIGS. 5a-5b, respectively), the identity of the Affinity Entity 396 need not be communicated to the donor. Rather, the donor can make a blind donation of the calculated amount to a third party for distribution to the Affinity Entity 396 in the Account Holder (p) 308's residential community. By such blind, albeit obligatory, donations, conflicts and disagreements between Account Holder (p) 308 and the donor as to right and proper objects of charity or affinity to the community can be avoided. As such, the Account Holder (p) 308 will transaction with community Merchants 310 by way of incentives from donors that they will donate to the Account Holder (p) 308's favorite charity (e.g., Affinity Entity 396), though the charity may not be the donor's favorite charity, or even a desirable charity, in that community. Nevertheless, the donors have received the benefit of customers' transaction, where each such benefit is realized by the donor's offer to make a donation to the customer's favorite charity(ies) if a timely transaction occurs subsequent to the donor's offer according terms and conditions defined by the donor.

Referring now to FIGS. 4a-4b, screen shots 402-404 feature input capture and rendered display fields by which a Donor can input terms and conditions under which the donor is willing to become obligated to make a donation to an Affinity Entity (k) 396. As such FIG. 4a is an implementation of a user interface that can be used by each donor, including the Account Holder (p) 308, the Merchant (m) 310, the Issuer (j) 304, the Transaction Handler 302, the Acquirer (i) 306, the Warehouse 110b, and the Delivery Service 110c.

Each row in screen shot 402-404 represents all or a portion of the twenty-four (24) hour day of the 356 calendar days of one (1) year. Columns in each row of the table seen in screen shot 402 are, from left to right, as follows: 1^{st}: the numerical calendar day of the year; 2^{nd}-3^{rd}: the hyphenated starting and ending of a time period within the calendar day; 4^{th}: a percentage of a currency amount of any one (1) transaction that the donor (e.g., Merchant (m) 310) will commit to make to an Affinity Entity (k) 396; 5^{th}: the minimum currency amount of the transaction before the commitment by the donor (e.g., Merchant (m) 310) to make the donation will arise; 6^{th}: the maximum amount of donation that donor (e.g., Merchant (m) 310) is willing to make for any one (1) transaction; and 7^{th}: an identifier for the Affinity Entity (k) 396 to whom the donor is to make the donation as described in the row. Note that, in some implementations where the customer picks the Affinity Entity 122, then the seventh column may not have data entered. In other implementations, the seventh column is a constant Affinity Entity 122 that does not change, for example, where the Affinity Entity 122 is not changeable (e.g., The United Way, the Red Cross, etc.) The bottom of screen shot 402 allows specification inputs for the donor as to its maximum donation across all Affinity Entities 396 (k) for any one day, month, quarter of a year, or year.

By way of example, and not by way of limitation, the data input by the donor for display on screen shot 402 can obligate a donation to be made to an Affinity Entity 122 that is higher at some days and times of the calendar year, and lower at other days and times of the calendar year. As such, it may be advantageous for the donor to provide proportional incentives by way of a higher donation incentive for typical slow business time-period of different calendar days and a lower donation incentive for typically busier business time-period of different calendar days.

Much of a community resident's spending occurs near the physical address of the resident's home. As such, it may be economically desirable for a merchant to provide its donation incentive only to those residents whose physical address is close enough to be regularly incentive by the merchant's donation offer, while not offering this incentive to others who would be unlikely, due to physical separation, to regularly shop at the merchant's physical location. Accordingly, and depending upon factors such as the demographics, population density, affluence, etc. of the physical location of the merchant, the merchant may input different navigation ranges for different likely-to-be-frequent shoppers according to any of the transportation modes that these potential-frequent shoppers are likely to take should these shoppers know and understand the merchant's donation incentive offer that is being made to them if they conduct a transaction with the merchant. Accordingly, the merchant may input at screen shot 404 any of various different travel methods (e.g., walking, automobile, bicycle, mass transit, etc.) and navigation time ranges.

Referring now to FIG. 4b, screen shot 404 allows a merchant, or its agent, to input one more minimum and maximum navigation times for different times on different days of the year. Each input navigation time range is used to determine whether or not the merchant will be obligated to make a donation to each Affinity Entity 396 (k). In practice, information derived from an affirmative authorization response for a transaction between the merchant and an account holder is obtained. This information will contain sufficient data that can be further used to retrieve and/or determine physical address information for the merchant and the account holder. Once physical address information for the merchant and the account holder customer are known, these physical addresses are used with a navigation time algorithm to determine the navigation time from the physical address of the account to the physical address of the merchant. If the determined navigation time is within the input minimum and maximum navigation time for one or more transportation nodes seen in the middle of screen shot 404 in FIG. 4b, and the date and the date and time of the transaction are within a time period and day as provided by the merchant's input as seen at the top of screen shot 404, then each donor who made commitment to donate (the Community Resident 110, the merchant, the issuer 114, the acquirer 113, the transaction handler for the issuer 114 and acquirer 113, the Warehouse 110b, and/or the Delivery Service 110c) will be obligated to make a donation to an affinity entity or charity. Otherwise, the donor is not obligated to make a donation to an affinity entity or charity.

The one or more different transportation modes seen in screen shot 404 of FIG. 4b each show minimum and maximum navigation times for different transportation modes. One such transportation mode can be by automobile, another by walking, and other by mass transit, another by a specific combination of different transportation modes (e.g., walk, subway, bus, and walk), etc.

Any of various navigation algorithms, both known and yet to be developed, can be used to determine whether the time, using one or more travel methods, is within the merchant's input navigation time range. The result of the algorithm's determination will ascertain whether or not the merchant and its customer share the same local community or ‘neighborhood’, and the merchant will accordingly be obligated to make donation when the customer buys something from the merchant. By way of example, the merchant and its customer might be determined to be within the same local community if the automobile drive time, as determined from one or more databases of contemporary cartographic road system information, to navigate between the merchant's brick and mortar store and the customer's residence is less than a predetermined time threshold (e.g., 17 minutes). The navigation algorithm used with the input from screen shot 404 and the respective physical addresses of merchant and account holder can be varied.

As stated above, the majority share of a community resident's annual spend, at least for some communities, tends to stay in their local community, a merchant in that community would like to incentivize residents in that community to conduct transactions with the merchant. As such, the merchant residing in a heavy-local spending community can choose to make an offer to any such Community Resident 110a that a donation will be made to one or more Affinity Entities 396 (k) that are designated by the Community Resident 110a. The donor's donation, however, can be made conditional. One such condition can be that the Community Resident 110a resides in the community where the transaction is conducted with the merchant—where the Community Resident 110a's residence criteria are made upon a derivation of a specific navigation algorithm. A commercial reason behind the merchant's donation incentive is to attract customers who are likely to be repeat customers who will frequently shop at the merchant's store. Although somewhat dependent upon the type of goods and services provided by the merchant, and the location where the merchant is physically located, the type of customer that is most likely to be a repeat, frequent customer might be determined to be one who lives or works relatively close to the merchant's store. As such, screen shots seen in FIGS. 4a-4b provide input fields to receive incentives directed towards likely frequent shoppers, while disallowing donation incentive to customer who will be unlikely to travel to the merchant's store frequently due to distance, difficulty of the commute.

In some implementations, the obligation for the merchant to donate can be tested in a variety of ways. One test for the customer's residence can be made by calculating the duration of a trip to navigate from a geographic location associated with Community Resident 110a to a geographic location associated with the merchant. This calculation can be made by using one of more navigation time estimation algorithms. Stated otherwise, the duration of a trip to navigate from a geographic location associated with an account holder to a geographic location associated with the merchant can be calculated by using one of more navigation time estimation algorithms. By way of example, and not by way of limitation, any of the following algorithms, either alone or in combination, can be used when calculating a navigation time between places respectively associated with customer and merchant: (i) Depth-First-Search (DFS); (ii) backtracking search; (iii) Dijkstra's algorithm; (iv) Krushkal's algorithm; (v) Prim's algorithm, (a.k.a. DJP algorithm; (vi) the Jarnik algorithm or the Prim-Jarnik algorithm; (vii) Reverse-Delete algorithm; (viii) Borvka's algorithm; (ix) a navigation algorithm now conceived; (x) a navigation algorithm both conceived and reduced to practice; and/or (xi) a navigation algorithm that is developed in the future.

Another way to calculate navigation time between places respectively associated with customer and merchant is to outsource calculations to a public or private web service by transmitting the respective geographic place identifiers to an online navigation service for calculation of navigation time and receive by the navigation time estimate. By way of example, the pair of places can be sent to an online service for subsequent return of a navigation time estimate as are provided by a Google® maps service, a Bing® maps service, a Garmin® maps service, a Delorme maps service, a TomTom® maps service, a Mapquest® maps service. The navigation time estimate calculated, or received back from a web mapping service, can be a time for one or more transportation modes, including walking, automobile or taxi, bicycling, mass transit, or a combination thereof.

As shown in FIGS. 4a-4b, a merchant can designate, if each of several different time periods during each calendar day, the navigation time under which the merchant will make a donation to one or more charities designated by a customer who transacts with the merchant, as well as the corresponding percentage of the transaction amount that the merchant will donate. As such, a merchant can input data such that a greater or lesser donation is made as depends up the time, the day, and the navigation time, by any of several different modes of transportation, between locations respectively associated with the merchant and the customer who transacts with the merchant.

In the case of a geographic area having a high-density population (e.g., a city), a merchant may input small navigation times because local shoppers live close to the merchant's location. As such, the merchant is thereby committing to donate only those charities designed by customers who live close to the merchant—such as in ‘ walking distance’. Alternatively, in rural and sparsely populated areas, the merchant may input larger navigation times because local shoppers are likely to drive in an automobile as the most reasonable transportation mode to arrive at the merchant's store. As such, the merchant is thereby committing to donate only those charities designed by customers who live close enough to drive a reasonable distance to the merchant's store.

A merchant may choose not to make a donation to any customer who is identified with a residence or location that is too far from the merchant's location to represent potential frequent repeat business. As such, input by the merchant would be unfavorable towards any donation to the designated charities of a shopper who is unlikely to regularly shop at the merchant's business.

The navigation time input by the merchant might preferably be dependent upon the types of goods and services provided by the merchant. Merchant offering only commodity items, such as grocery stores, would be like to input shorter navigation times that merchants typically providing rare and hard-to-find items for which customers are more likely to be willing to make longer commutes in order to make purchases.

FIG. 4b allows a merchant to input different navigation time thresholds for any of several different kinds of transportation modes, such as walking, driving, mass transit, and there combinations. For instance, if at least one of the navigation times from a customer's residence to the merchant's store for different transportation modes is less that an input threshold, then the merchant will make a donation the customer's identified charities after the customer's transaction with the merchant has been authorized.

FIG. 4b shows a portion of screen shot 404 where the merchant can input an identifier for one or more customers (e.g., an account or member number), where the merchant will donate to each such customer's identified charities. Note that, in this implementation and variations thereof, the merchant's obligation to donate is fixed regardless of any navigation time that may apply for the customer to travel from the customer's resident to the merchant's store, although other criteria may apply, such as the date and time parameter seen in FIG. 4a which must be satisfied by the date and time of the transaction. Alternatively, input can be made by the merchant per screen shot 404 in FIG. 4b such the merchant will donate to each identified customer's charities regardless of navigation time or time of day, though within the limits of donation see at the bottom of screen shot 402.

The local community of each of the merchant and its customer can be determined in still other ways in other implementations, where each donor's obligation to donate will not be fixed unless the respective physical addresses of merchant and customer are in the same community or neighborhood according to a predetermined algorithm. Any such local community determination can be made in any of several different methods, or combinations thereof, according to the merchant's preference as to what algorithm is mostly likely to attract the most favorable foot traffic to the merchant's brick and mortar store. One such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same or within a predetermined proximity as that of its customer's residence. Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

A further alternative implementation will use an algorithm that uses the population density of the merchant's brick and mortar store and the customer's residence, as well as real time transportation data such as traffic conditions, bus and subway availabilities, etc. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes).

Still another such comparison can be whether the merchant's place of business and its customer's residence are proximate or the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

Similar or different algorithms that are used to determine the respective local community of the merchant and its customer can also be used to determine the local community of an Affinity Entity such as that shown on FIG. 1 at reference numeral 122, or as that shown as an Affinity Entity (k) 396 in FIG. 3, as discussed herein below. These determinations can be performed when a donation term is conditioned upon the location, neighborhood or community of the Affinity Entity (k) 396.

Data input in the user interface depicted by screen shots 402-404 can be stored in one or more of the Merchant DBs 380 or other location logically accessible, via one or more networks or otherwise, to Donation Audit Web Service 394. These data can also be automatically pre-loaded for Merchant (m) 310 via an automatic initiating service (e.g., an data auto-boarding or auto-populating operation) that allows the Merchant (m) 310 to be automatically entered as a participant in a local community charitable donation program that incentivizes increased local resident foot traffic to each store location of the Merchant (m) 310 in the local community. Note that auto-boarding allows small and medium sized merchants to enter such a program with little or no effort by using default data in auto-populating information to be used for the merchant's participation in the program.

As seen in FIGS. 4a-4b, each offer input by a donor (the merchant from whom a Packaged Purchase 110d is to be received by the Community Resident 110, the Community Resident 110, the issuer 114, the acquirer 113, the transaction handler for the issuer 114 and acquirer 113, the Warehouse 110b, and/or the Delivery Service 110c) to donate to a local Affinity Entity 396 (k) is not be specific to a particular good or service that the merchant will provide to its customer in a transaction. Rather, the offer is specific to the entire transaction between the merchant and its customer. By way of example as to this type of offer specificity, the offer may obligate the donor to make a donation of a certain percentage of the entire currency amount of transaction, or the offer may obligate the donor to make a donation only if the transaction is conducted at a certain time of day or on a particular day of the week, or a combination of the foregoing. Although some terms of the offer may differ from some terms of the transaction, nevertheless, the donor's offer to make a donation to a local Affinity Entity 122 (e.g., a local charity) has the goal of fundamentally providing an incentive that causes, at least in part, the local Community Resident 110a to use a browser to navigate to the local Merchant's e-Commerce Website 106, and ultimately to conduct a transaction that brings revenue to the local community of the Community Resident 110a.

By way of exemplary implementation of data input to a field in screen shot 402, a received identifier might identify a specific Affinity Entity (k) 396 that is located in, and provide goods and services to, the borough of Greenwich Village at the southern portion of the geographical island of Manhattan in the city of New York of the State of New York, in the USA. By way of example, and not by way of limitation, an Affinity Entity Code having the character string “105(064) (q2e)”, which would be input in the 7^{th} column of screen shot 402, could have an interpretation where ‘105’ represents the United States of America, the index ‘064’ represents the state of New York, “q” represents the City of New York, “2” represents the combined boroughs of Manhattan, and “e” represents the borough of Greenwich Village at the southern portion of the geographical island of Manhattan in the city of New York of the State of New York. The name of the specific Affinity Entity (k) 396 represented the character string “(105) (064) (q2e)” can be the Washington Square Food Bank, which may be located in, and provide goods and services to, the borough of Greenwich Village at the southern portion of the geographical island of Manhattan in the city of New York of the State of New York, in the USA.

Note that the donor can use screen shot 402 to specify multiple community IDs each representing a geographic location where the Account Holder (p) 308 either has a residence or operates a business in the geographic location. Also note that, for each such community ID specified by the donor, the second column of the rows of screen shot 404 in FIG. 4b will preferably add up to 100%, thereby provide a percentage the donation made by the Merchant (m) 310 with whom the Account Holder (p) 308 conducting a transaction.

For screen shots 402-404, input and selection of data for each Affinity Entity can be via a typical user experience including but not limited to keyboard data entry, pull down menus, pictograph optical scanning with a cellular telephony device as read from print or electronic media rendering, etc. Horizontal 418 and vertical 420 panning can be user activated to move that portion of the display being rendered horizontally and vertically, respectively.

Referring now to FIGS. 5a-5b, a screen shot 502 features input and displays fields by which an Account Holder (p) 308, or agent thereof, can direct a third party donor, such as the issuer 114, the acquirer 113, the transaction handler for the issuer 114 and acquirer 113, the Warehouse 110b, the Delivery Service 110c, and/or the Merchant (n) 310 with whom the Account Holder (p) 308 is conducting a transaction, to become legally bound to make a donation to an Affinity Entity 396 (k). Alternatively, or in combination, these data fields can be auto-populated in an auto-boarding process that facilitates immediate participation by Account Holder (p) 308 in the above described donation program. Each row in screen shot 502 represents a different affinity entity. Other donors so directed by the Account Holder (p) 308's data entry can optionally include each issuer (j) 304, the transaction handler 302, the acquirer (i) 306, the transaction handler for the issuer (j) 304 and acquirer (i) 306, the Warehouse 110b, and/or the Delivery Service 110c. The Affinity Entity (k) 490 is expressed in each row by an integer indexed in both T and T variables. By way of example, such an indexing system might identify a specific Affinity Entity (k) 390 by the code 105(064) (q2e), where ‘105’ represents the international charitable organization “United Way”, the index ‘ 064’ represents that organization's affiliated charity within the United States of America, and the index ‘ q2e’ represents the borough of Greenwich Village at the southern portion of the geographical island of Manhattan in the city of New York of the State of New York.

Other columns in each row of the table seen in screen shot 502 are, from left to right, as follows: 1^{st}: the percentage of the donor's donation that the account holder directs to be donated to the charity identified in the 2^{nd} column; 3^{rd}: a yes or no indication whether the account holder will match the donor's donation to that charity; and the 4^{th} through the 7^{th} columns: the maximum currency amounts that the Account Holder (p) 308 will commit to give to the identified charity for the current year, quarter, month and day, respectively. The bottom of screen shot 502 allows a customer to specify the maximum total of all matching contributions to all Affinity Entities 396 (k) that the Account Holder (p) 308 is willing to commit for the current year, quarter, month and day, respectively.

Screen shot 504 in FIG. 5b shows a plurality of rows. Each row includes an affinity entity, the percentage of any donation that the account holder requires to be made to that affinity entity, an identifier for a community associated with the affinity entity, and a description or name of the affinity entity. Note that the sum of the second column of the row must equal one hundred percent (100%).

For the Account Holder (p) 308 to make the matching donations to the Affinity Entities 396 (k) that are specified in screen shot 502 of FIG. 5a, the Account Holder (p) 308's issuer (j) 304 can pay the Affinity Entities 396 (k) and place a debit in that currency amount on the Account Holder (p) 308's periodic revolving credit statement. The Account Holder (p) 308, upon receipt of the statement, can thereafter make a total payment to the issuer (j) 304 of the currency amount of the donation that appears as a debit on the statement along with the other credit charges that also appear on the Account Holder (p) 308's statement.

For screen shots 402-504, input and selection of data for each Affinity Entity 396 (k) can be via a typical user experience including but not limited to keyboard data entry, pull down menus, pictograph optical scanning with a cellular telephony device as read from print or electronic media rendering, etc. Horizontal 418, 518 and vertical 420, 520 panning icons can be user activated to move the rendered display, respectively, on screen shots 402-504.

The Account Holder (p) 308 and each donor (the issuer 114, the acquirer 113, the transaction handler for the issuer 114 and acquirer 113, the Warehouse 110b, and/or the Delivery Service 110c) can change or disable a donation commitment at any time by accessing a server that serves web pages rendering screen shots 402-504. Thus, charitable donation commitments can be easily and instantly, and both enabled or disabled, using the real time user interface. By way of example, and not by way of limitation, one or more of such servers can be hosted by the Donation Audit Web Service 314 seen in FIG. 3.

In some implementations, the fields provided by screen shot 502 allow the customer to specify one or more Affinity Entities 396 (k) in their local community to which donations are to be made by donors whenever the customer conducts a transaction with a merchant. In such implementations, each donor is given notice of its total periodic donations. Such notice, however, can optionally be given without providing the donor with any notice or knowledge as to the specific identity of those affinity entities that are to be the recipients of its donations. The donation mechanism can be set up such that the donor makes blind donations, either directly or indirectly, to affinity entities in the local community of both the merchant and its customer who selects those local community affinity entities. Accordingly, the donation mechanism can leave direction of donations fully within the discretion of the merchant's customers, limited only by the restriction that the customer can only select from among those affinity entities that serve the local community that is in common to both the merchant and the customer, while leaving the actual amount of the donor's donation fully within the discretion of the donor as shown with respect to FIGS. 4a-4b.

Optionally, a further limitation on those local community Affinity Entities 396 (k) that can be selected by the customer can include an algorithm that accesses a rating, and/or that derives a rating, for an Affinity Entity 396 (k). The algorithm can use one or more ratings given by one or more charity rating organizations, where the algorithm's result is used to determine whether or not the Affinity Entity 396 (k) is eligible for participation in the implementation as a registered affinity entity that is selectable by local community customers. The ratings can be retrieved by Donation Audit Web Service 314 by its access to one or more databases where such ratings are input and maintained. Example of charity rating organizations which provide one or more ratings that could be used for various disclosed implementations include Guide Star, Charity Navigator, Give Well, Evangelical Council for Financial Accountability (ECFA), the Better Business Bureau Wise Giving Alliance Standards for Charity Accountability of the Council of Better Business Bureaus, Inc., and the like that now exist or may exist in the further. Moreover, the reader will understand that current or future developed algorithms for assessing local community affinity entities can be used to determine whether or not Affinity Entities 396 (k) are eligible for participation in the disclosed implementations as registered affinity entities that are selectable by local community customers and/or local merchants.

Still another implementation relates to an open loop cashless payment system that incents an account holder to transact with a merchant who, along with other donors, agrees to make an auditable donation to an affinity entity or charity when the transaction is conducted on an account issued to the account holder. The account holder can direct the donation to a specific charity within a predetermined geographically determined community where the transaction was physically conducted. The account holder can register an obligation to make a donation matching that of one or more of the donors, where the account holder's donation is initially paid by the account's issuer for reimbursement by the account holder to the issuer after the account holder receives their account statement. The delivery service, the merchant's acquirer, the issuer, and a transaction handler for the issuer and acquirer can also make donations as directed by the account holder. Various donor and account holder directed business rules limit the total currency amount of donations over specific calendar periods.

Referring again to FIG. 1, an incentive to a Community Resident 110a to purchase food from a Merchant e-Commerce Website 106 for delivery via Delivery Service 110c can be a commitment from the Delivery Service 110c to make a donation to an Affinity Entity 112 selected by the Community Resident 110a. Merchants use a Delivery Service 110c for Community Residents 110a as a means to get food orders and help people avoid having to go into supermarkets and restaurants. By way of example, some brick and mortar grocery stores locations convert to a “dark store” that will only fill online orders for delivery to customers using their own delivery service or a third party Delivery Service 110c. By way of example, and not by way of limitation, Delivery Service 110c can be a taxi service, a third party contractor such as Uber, Federal Express (FedEx), United Parcel Service (UPS), DH1, the United States Postal Service (USPS), Delta Airlines' Delta Dash service, SkipTheDishes, Uber Eats, Doordash, Freshly, Instacart, Delivery.com, goPuff, GrubHub. Postmates, Caviar, ChowNow, Seamless, Munchery, Eat 24, etc.;

In placing a take-out food order for delivery to Community Resident 110a, the Merchant e-Commerce Website 106 may disclose to Community Resident 110a how much the merchant pays when Community Resident 110a orders food using a delivery app in communication with both Merchant e-Commerce Website 106 and with Delivery Service 110d. The Merchant e-Commerce Website 106 may show an itemized breakdown that lists how much the merchant will pay to Delivery Service 110c to deliver food to Community Resident 110a, as well as the menu price of each dish and beverage, the cost of delivery and tip as well as any taxes. Additionally, Community Resident 110a may see the breakdown both before and after the order is placed. By providing Community Resident 110a with more transparency when they using Delivery Service 110c, Community Resident 110a can require the Delivery Service 110d to make a donation to Affinity Entity 122 consistent with the charges that the Delivery Service 110d assessed to deliver the Packaged Purchase 110d to Community Resident 110a. The merchant may also influence the amount of the donation that is to be required of the Delivery Service 110d, particularly where the Delivery Service 110d does most of the deliveries for the merchant, and/or will receive a predefined percentage of the total cost of the transaction between the Community Resident 110a and the merchant for the food to be delivered to the home or place of business of the Community Resident 110a.

Delivery Service 110c will preferably use takeout packaging for Packaged Purchase 110d, when Community Resident 110a is to receive a delivered meal, that is tamper evident packaging to ensure that the packaging will show if a package has been opened. Community Resident 110a want their food delivered right to the residence or place of business with evidence that their meal is being delivered safely and without an interloper sampling the food while the food is being delivered. As such, the use of tamper evident bags for Packaged Purchase 110d is a defense taken to keep food secure. A tamper evident carryout bag allows for the Community Resident 110a's order to be sealed with an adhesive, and to be delivered without tampering of the food in the Packaged Purchase 110d. In preferred implementations, Packaged Purchase 110d will be sealed with a food delivery tamper evident label and/or a tamper evident tab to discourage pilferage or contamination by a third party driver with Delivery Service 110c. Such meal delivery security brings peace of mind to both customer and restaurants without fear of tarnishing the restaurant's name.

In other implementations, Delivery Service 110c provides for the delivery of items other than food deliveries. By way of example, and not by way of limitation, such other items to be delivered by Delivery Service 110c to Community Resident 110a can be items purchased in e-Commerce transactions, such as prescriptions, flowers, supplies for use by Delivery Service 110c to provide a service at the geographic location of Community Resident 110a, letters, parcels, machinery parts, laboratory specimens, law enforcement evidence, kitchen appliances, automobile parts, and other such items that were purchased by Community Resident 110a from online vendors that perform online sales services (i.e., Amazon, eBay, Overstock, Newegg, AliExpress, Jet.com, Barnes & Noble, Zappos, Rakuten, Walmart.com, Target, QVC.com., BestBuy.com, Etsy, etc.)

In still other implementation, the method by which Delivery Service 110c provides a delivery to Community Resident 110a can take different forms, such as: (i) third party delivery services that facilitate the delivery of a Packaged Purchase 110d that results from a transaction between a Community Resident 110a and Merchant e-Commerce Website 106 to purchase an item contained within the Packaged Purchase 110d (i.e. Uber eats, Door Ddash, Grub Hub, SkipTheDishes, etc.); (ii) an in-house delivery service offered by Merchant e-Commerce Website 106 (i.e. Domino's pizza, NowRx, etc.); and (iii) Package delivery services that are contracted by Merchant e-Commerce Website 106 or Community Resident 110a to deliver the Packaged Purchase 110d. (i.e. FedEx, USPS, UPS, DHL, Google Express, ShopRunner, NewEgg Premier, FreeShipping.org, etc.)

In yet another implementation, Merchant e-Commerce Website 106 can make an arrangement with an individual, partnership, or other juridical entity to provide delivery services for the Packaged Purchase 110d to Community Resident 110a. In such arrangements, the person or entity providing the delivery service for delivery of the Packaged Purchase 110d to Community Resident 110a will receive neither attribution nor a commission or percentage of the amount of the transaction. Rather, the Merchant e-Commerce Website 106 can make an arrangement to ship the Packaged Purchase 110d directly to Community Resident 110a through the person or entity while also requiring the person or entity to make a donation to the Affinity Entity 122 selected by the Community Resident 110a. These types of arrangements are unlike contemporary delivery service providers who typically require both attribution and a commission or percentage of the amount of the transaction. As such, these arrangements can reduce the local third party delivery costs that are paid to Delivery Service 110c by the merchant and/or the Community Resident 110a.

Implementations provide Community Resident 110a with access to chain of custody data with respect to food delivered to their residence or place of business that serves as evidence pertaining to their meal in the Packaged Purchase 110d. The chain of custody evidence establishes a witnessed, tangibly fix (e.g., written) record of all of the individuals who maintained unbroken control over the Packaged Purchase 110d. The chain of custody evidence establishes proof that the food inside Packaged Purchase 110d that was collected at the merchant's restaurant or grocery store is the same Packaged Purchase 110d that was delivered to the home or place of business of the Community Resident 110a. This chain of custody data can be used to ensure that only authorized individuals come in contact with the meal in the Packaged Purchase 110d, from beginning to end, thereby by demonstrating to the Community Resident 110a the presence of a tightly controlled chain of custody process for the food inside Packaged Purchase 110d. This Chain of custody data documents an automated “digital” trail by creating documentation on the food inside Packaged Purchase 110d with respect to: (i) where the Packaged Purchase 110d is during transit or where it's been during transit; (ii) who has the Packaged Purchase 110d at any one time; and (iii) where the Packaged Purchase 110d is going etc. Implementations employ an application enforcing tightly controlled documentation of a courier responsible for the pick-up, transport, and delivery of the Packaged Purchase 110d.

Further implementations require the courier to use a web enabled mobile computing device having installed thereon proof of delivery software with signature capture and GPS time-stamp features to provide visibility and traceability throughout the delivery process. This mobile software app provides chain of custody data assessable the Community Resident 110a with signature capture as proof of when the Packaged Purchase 110d was delivered to Community Resident 110a. A time-stamp feature pinpoints the time the Packaged Purchase 110d was received by Community Resident 110a. The mobile software app also allows a photo to be taken by Community Resident 110a of the Packaged Purchase 110d and/or the driver for Delivery Service 110c, linking the photo to the data, to show condition or other attributes of the Packaged Purchase 110d. At any time, whereabouts of a driver for Delivery Service 110c and Packaged Purchase 110d in the driver's custody can be monitored. Transaction history stored with the mobile software app provides a documented history of where and when the Packaged Purchase 110d was transferred from one control point/person to another during the entire process, pickup to delivery. Signature is captured at the time the Packaged Purchase 110d is delivered to the designated final location, closing the loop on the process of food or meal delivery from the kitchen of the merchant, or from the warehouse of the grocer, through the possession of the driver for Delivery Service 110c, to the home of the Community Resident 110a.

Food industry suppliers and participants are exploring blockchain technologies, Artificial Intelligence (AI), and the Internet of Things (IoT) as powered solutions to address food industry challenges. These challenges include fragmented supply chain processes, fraud, counterfeiting, and foodborne disease. Preferred implementations of the present Application use blockchain technology as a type of digital distributed ledger technology (DLT). DLT, as a blockchain-powered ledger, records end-to-end information in a shared yet immutable manner with encryption mechanisms across the network of stakeholders. These food industry suppliers and participants are stakeholders into foods chain that ensure the delivery of the needs of a restaurant or a grocer, Warehouse 110b, Delivery Services 110c, and Community Resident 110a. Moreover, implementations employ blockchain technology to ensure that no single entity gets the authority to access or manipulate information of or relating to the acquisition, movement, and/or delivery of food from food supplier to merchant to Delivery Service 110 to Community Resident 110a. As a result, DLT establishes trust, transparency, and efficiency in the food distribution network, and eliminates the need to have one centralized system that is totally controlled by a single governing body and thus, many other complexities.

The food supply chain stakeholders, including manufacturers, processors, suppliers, and customers, when using the blockchain-powered ledger, access end-to-end product records from their provenance to the dining table. With blockchain-powered provenance traceability, each Community Resident 110a can access and know where food related data came from while tracing the food's entire history as well as changes to any food related information in regards to a food purchase by the Community Resident 110a.

Blockchain-powered surveillance can keep track of each link (transaction) in the food chain, and enables real-time end-to-end traceability of food fraud culprits and establishes accountability. Further, it facilitates secure data exchange among food chain stakeholders to prevent participants from moving fraudulent foods unknowingly. The improved transparency enables fewer opportunities for fraudsters to penetrate the food supply chain. The immutability of blockchain records ensures efficient management of material safety and quality standards.

Supply chain members can trace food products in the supply chain upstream and downstream, and can determine the authenticity of both raw ingredients and packaged goods. When participants in the food chain securely upload, manage, and access transactional data, fraudulent activities along the supply chain can be detected. Additionally, users can also share inspections, quality certifications, and registrations to the blockchain network. This enables accountability for acquired data at each step. With end-to-end transparency powered by blockchain's distributed ledger, stakeholders can be assured of the quality of food at all stages of the food chain. With the traceability of each step of the food supply chain and sharing of data on an immutable ledger, participants promise to sustain the quality of goods. A blockchain based food traceability solution enables users to know the products provenance, its real-time location, and status. If a food safety issue is reported, it is immediately clear who is impacted and who should take action. Additionally, organizations can know which foods have been grown or produced in a certified manner. Consequently, surveillance via block technology can help to eliminate contamination risks and potentially harmful food fraud along the supply chain, and further provide mechanisms by which collaborations can be enabled for food system participants, such as suppliers, manufacturers, distributors, and retailers. When participants securely and transparently trace the location and status of food products upwards and downwards in seconds, they can better manage food safety within their supply network.

Blockchain improves the way food is tracked, transported, or sold. Blockchain addresses inaccuracies occurring due to traditional paper-based records. In food recall or investigation scenarios, blockchain's end-to-end traceability can enable seamless operations. Blockchain can considerably ensure food safety. It can save lives while enabling efficiency. Food wholesalers can provide logistic services to distribute items to different retailers. To keep the food items safe under the controlled temperature, IoT-enabled vehicles or trucks can transport the processed food. IoT enabled vehicles can transmit real-time information related to the temperature and location of food items to the blockchain platform. It can enable retailers to track food items they are going to receive. The blockchain food supply chain, as proposed herein, has information from source to destination, including details of crop origination, processing, transportation, storage temperature, expiration, and others in an immutable and readily accessible manner. As such, Community Resident 110a can check every detail of a specific food item to ensure its authenticity from farms to the table with records stored on the food supply chain solutions built with blockchain for the entire chain of transactions which becomes an immutable and permanent record. Blockchain technology, as propose herein, uses a decentralized, shared ledger that enhances the legacy food system by way of a food delivery software application for on-demand food delivery services. The food delivery software application uses blockchain to decentralize a food delivery network and provide the advantages of data and privacy security, identity management, food traceability, simplified audit processes, and end-to-end transparency.

In prior art food ordering software applications (“app), the customer registers name, address, and location of the delivery. Next, the customer logs into the app and searches for the restaurant and add food to the electronic shopping cart. Then, the customer selects the payment method and orders the food. The order is assigned to a particular restaurant. The restaurant cooks the food, and the food app company assigns a delivery partner to the restaurant. The delivery partner picks up the food in the Packaged Purchase 110d and uses a map to deliver the Packaged Purchase 110d to the customer, such that, starting from sourcing the material in the restaurant to delivering the food to the customers, a supply chain, albeit unreliable, is formed. The customer doesn't have any idea about the hygiene conditions of the food while it is being prepared or the quality of the food delivered. The same is with the restaurant, which does not know the quality of the material being used for making the food. An unreliable supply chain is a reason for this.

In various implementations, the present Application uses a smart contract (e.g., a computer program) that directly controls the transfer of data between parties under certain conditions. Each stakeholder in the supply chain can update the information about the food in a digital ledger. The smart contract works automatically by matching the data in the ledger with the already present standard data. The supplier of raw materials can update the quality and price of the ledger. The restaurant owner, in turn, can assure the quality of materials by using the output data from a smart contract. The same applies to restaurants. The app admin can verify the quality of food being delivered using a smart contract.

Using blockchain technology as proposed in the present Application, a quality assessment can be given to the food delivered in Packaged Purchase 110d by Delivery Service 110c by using the blockchain technology as disclosed in U.S. patent application Ser. No. 16/446,728, titled “Blockchain Tracking and Managing of A Transaction Incented By A Merchant Donation To A Consumer Affinity”, filed on Jun. 20, 2019, and published as US Patent Application Publication No 20190392189 on Dec. 26, 2019, which is incorporated hereinafter by reference and is referred to hereinafter as the “NOG-Blockchain Reference”.

In the NOG-Blockchain Reference, a transaction is conducted between a merchant and an account holder for a purchase. The transaction is conducted on an account issued to the account holder by an issuer, the merchant is obligated to make a donation to a charity as a condition of the account holder conducting the transaction with the merchant. Data fields are derived from the transaction that include: (i) first data for the transaction defined using a first merchant account; and (ii) second, different data for the same transaction defined using a second merchant account. The first and second data for the transaction are received and used to create a first block from the first data for the transaction defined using the first merchant account. The first block is added to a first blockchain that uses the first merchant account to track transactions. A second block is created from the second data for the transaction defined using the second merchant account without including the first data for the transaction defined using the first merchant account. The second block is added to a second, separate blockchain that uses the second merchant account to track transactions. The first and second blockchains each track different transaction data fields. The transaction is validated between the merchant and the account holder by: (i) receiving a Globally Unique IDentifer (GUID) for the transaction; (ii) using the GUID to identify indices in the first and second blockchains; (iii) retrieving encrypted blocks from the first and second blockchains of the identified indices; (iv) verifying a hash associated with the encrypted blocks; (v) decrypting at least one of the encrypted blocks using a private key; and (vi) transmitting information sufficient to facilitate the donation to the charity which is facilitated by a predetermined smart contract having an Internet computer protocol operating so as to digitally facilitate the performance of the donation according to terms and conditions of the predetermined smart contract.

In some embodiments, hyperledger fabric may be used to implement various aspects described herein. Hyperledger fabric is a blockchain framework implementation and one of the Hyperledger projects hosted by The Linux Foundation. Hyperledger Fabric allows components, such as consensus and membership services, to be plug-and-play. Hyperledger Fabric leverages container technology to host smart contracts that comprise the application logic of the system. Hyperledger Fabric is a permissioned network where all users and components have known identities.

A network (e.g. hyperledger fabric) may include various components such as ledgers, smart contracts, peers, ordering services, channels and fabric certificate authorities. For an identity to be verifiable, the identity must come from a trusted authority. A membership service provider (MSP) may act as the trusted authority in the hyperledger fabric. More specifically, an MSP may include a component that defines the rules that govern the valid identities for an organization. The default MSP implementation in Hyperledger Fabric uses certificates as identities adopting a traditional Public Key Infrastructure (PKI) hierarchical model. Other certificates may be used according to various embodiments. Embodiments such as hyperledger fabric can provide modular and configurable architecture, enabling innovation, versatility and optimization for a broad range of use cases.

When applying the blockchain technology discussed in the NOG-Blockchain Reference to the present Application, the Delivery Service 110c assesses a charge for the delivery that is a percent of the transaction as a commission for each order. The credibility of the delivery partner and restaurant are both important with respect to food quality and professional handling of the delivery. A smart contract (e.g., a computer program) is used that employs the blockchain technology as disclosed in the NOG-Blockchain Reference to automatically verify the documents and licenses for both the restaurant and Delivery Service 110c. In case of any discrepancies in the documents, the Web Service 100, as administrator, is alerted. As applied to the present Application, the blockchain technology as disclosed in the NOG-Blockchain Reference uses digital DLT that records end-to-end information in a shared yet immutable manner with encryption mechanisms across the network of each supplier of the various components of the food and its packaging that makes up Packaged Purchase 110d for delivery by a delivery service to the home or business of Community Resident 110a who ordered the takeout food. Smart contracts, as proposed for use in various implementations, make use of blockchain technology to expedite cashless payments by Community Resident 110a during the acceptance of delivery of Packaged Purchase 110d, business-to-business payments between Web Service 100, the merchant-restaurant, and the material supplier. These business-to-business transactions are done using smart contracts that work automatically to verify the data by use of blockchain technology as disclosed in the NOG-Blockchain Reference.

Couriers for Delivery Service 110c are under pressure to deliver orders while also adhering to new safety protocols such as contactless delivery of Packaged Purchase 110d at the doorstep of Community Resident 110a to ensure driver and customer safety. Many such last mile providers work with non-traditional fulfilment centers and distributed networks to provide last mile deliveries. In addition, last mile providers are also utilizing connectivity applications allowing Community Residents 110a to request deliveries be left at their door and be alerted by text message (e.g., SMS) or push notification. Other options allow Community Residents 110a not to sign on delivery, but to have the driver sign or offer a recorded proof-of-delivery. This trend is presenting a challenge for the delivery industry where several last mile deliveries are contracted to third-party carriers. These carriers must balance the requirements of safety and social distancing with the need for proof-of-delivery. The new safety protocols are causing an increase in long delivery windows and order errors.

Referring now to US Patent application Ser. No. 16/0148,431, filed on Jun. 21, 2018, titled “Non-Contact Biometric Identification System”, and published as US Patent Application Publication No. 20190392189, on Dec. 26, 2019, which is incorporated herein by reference and referred to herein after as the “Non-Contact Delivery Reference”, there is disclosed a non-contact biometric identification system for contactless delivery of a packaged purchase to a customer. The Non-Contact Delivery Reference includes a hand scanner that generates images of a user's palm. Images are acquired using light of a first polarization at a first time show surface characteristics such as wrinkles in the palm while images acquired using light of a second polarization at a second time show deeper characteristics such as veins. Within the images, the palm is identified and subdivided into sub-images. The sub-images are subsequently processed to determine feature vectors present in each sub-image. A current signature is determined using the feature vectors. A user may be identified based on a comparison of the current signature with a previously stored reference signature that is associated with a user identifier.

Preferred implementations for the present Application include use of the Non-Contact Delivery Reference in order to: (i) associate Community Resident 110a with a method of payment (e.g., debit or credit account) for the Packaged Purchase 110d; and (ii) contactlessly accept delivery of the Packaged Purchase 110d from a driver for Delivery Service 110c by way of invisible light illuminating and accepting images of the palm of the Community Resident 110a, which images are matched with previously stored images to thereby confirm the identity of the Community Resident 110a who is accepting delivery or, and paying for, the Packaged Purchase 110d.

Referring now to U.S. patent application Ser. No. 14/973,918, filed on Dec. 18, 2015, titled “Devices, Systems And Methods For Managing Feedback In A Network Of Computing Resources,” published as US Patent Application Publication No. 20160180360, on Jun. 23, 2016, which is incorporated herein by reference, there is provided a network communication system for feedback that has one or more merchant systems. As applied to the present Application, implementations include each merchant system having a transaction processing device for triggering transmission of a transaction notification alert, and a location device for generating and transmitting location data for the one or more merchant systems. Each transaction involves a purchase by a Community Resident 110a from a Merchant e-Commerce Website 106 for the delivery of the purchase to the Community Resident 110a in a Packaged Purchase 110d by a Delivery Service 110c. The feedback from Community Resident 110a can include a photograph taken by the Community Resident 110a of the Packaged Purchase 110d when it is delivered to the home of place of business by a Delivery Service 110c.

The network communication system has a transaction notification system for collecting transaction notification alerts from the one or more merchant systems and transmitting a transaction notification data feed compiling the collected transaction notification alerts. The network communication system has one or more cardholder devices configured to receive and process speech signals for feedback requests and generate speech signals for feedback responses. Each feedback response is received from Community Resident 110a and will pertain to feedback about one or more of the Merchant e-Commerce Website 106, the merchant from whom a purchase was made by Community Resident 110a, the state of condition of the Packaged Purchase 110d, and/or the Delivery Service 110c. The feedback response can include audio, video, audio-visual, and visual data.

Community Resident 110a can provide the foregoing feedback by way of a web enabled mobile computing device capable of capturing feedback in the forms of textual, audio, video, audio-visual, and visual data. The web enabled mobile computing device can be a cardholder device that can comprise location detection hardware for generating location data for the cardholder device. The network communication system has a feedback component that has a text to speech processor for generating the speech signals for the feedback requests using feedback request data records. The feedback component has a speech to text processor for generating feedback response data records by transforming the speech signals for feedback responses received from the one or more cardholders devices. The feedback component has notification management processor for managing transmissions of the speech signals for feedback requests by determining, for each feedback request, a respective delivery notification delay. The feedback component has a transceiver for transmitting and receiving the feedback request data records and the feedback response data records. The transceiver transmits a portion of the feedback request data records or the speech signals for feedback requests after expiration of the respective determined delivery delay in response to a location notification. The feedback component has a network interface for connecting to the one or more merchant systems, one or more cardholder devices and the transaction notification system for data exchange. The feedback component has location tracking hardware for correlating the location data for the one or more cardholder devices to the location data for the one or more merchant systems to generate the location notification to trigger the transmission of the speech signals for feedback requests. The feedback component has one or more data stores for storing feedback request data records and the feedback response data records.

In accordance with another aspect, there is provided a method for managing feedback communications in a network of computing resources. The method includes: receiving, by at least one processor, at least one transaction communication, the at least one transaction communication including data associated with an electronic transaction involving a payment identifier associated with a customer profile; initiating signals to cause a trigger handler to establish a trigger condition for initiating a feedback acquisition based on the data associated with the electronic transaction; and upon detection of the trigger condition, initiating signals to cause a input device to receive feedback input.

In accordance with another aspect, there is provided a non-transitory, computer readable medium or media having stored thereon computer-interpretable instructions. When executed by at least one processor, the computer-interpretable instructions configure the at least one processor for: receiving at least one transaction communication, the at least one transaction communication including data associated with an electronic transaction involving a payment identifier associated with a customer profile; initiating signals to cause a trigger handler to establish a trigger condition for initiating a feedback acquisition based on the data associated with the electronic transaction; and upon detection of the trigger condition, initiating signals to cause a input device to receive feedback input.

Referring now to U.S. patent application Ser. No. 16/170,186, filed on Oct. 25, 2018, titled “Community Merchant Cross Selling/Promoting With Shared eCommerce Shopping Cart For Items Selected By Community Residents Incented To Conduct Transactions To Incent Community Donations,” published as US Patent Application Publication No. 20190130462, on May 2, 2019, which is incorporated herein by reference, there is provided a series of associated merchant websites or respective merchant websites each selling narrowly defined product categories to shoppers.

Each shopper browses to select products for placement into a virtual e-commerce shopping cart. As applied to the present Application, implementations feature each website being operated and controlled by a different merchant or a single merchant, with each website having access to a shared server farm where information about each shopper is stored. Also shared is the virtual e-commerce shopping cart that the shopper can use to check out at any of the merchant websites even though the virtual e-commerce shopping cart may contain products from multiple different merchant websites.

Each merchant website is associated with metadata limited to the narrowly defined product category, thereby providing enhanced Search Enhances Optimization (SEO) benefits without the need to purchase advertisement (ad) words. Each boutique specifically targets a single category making the shopping and buying experience easier. Information gathered from shoppers at each unique boutique is stored at the server farm for being shared with other associated merchants in the collection of sites. A shopper's user account will transfer between sites and allow the data gathered to be used in a cross-promotional method and will ensure the shopper's experience is consistent with what they like and want in future visits. Moreover, a merchant incentivizes an account holder to make an authorized transaction by terms and agreement to auditably donate to the account holder's affinity entity. To incent desirable commerce with locals, the merchant's terms may limit its donation by a derivation of navigation time between account holder and merchant, and/or by date and time of the transaction. The account holder can direct the donation to one of more affinity entities within their own community, and/or within a community where the transaction was physically conducted. An account holder can also donate at the time of transaction where the donation is paid by the account's issuer for reimbursement as a debit to the account holder's account statement. Other payment system participants may be donors, including the merchant's acquirer, issuer, the transaction handler for the issuer and acquirer, the warehouse, and the delivery service. As such, each donor can define those circumstances under which the donor will make a pre-defined audible donation to an account holder selected affinity entity.

Given the foregoing, implementations disclosed herein provide incentives to an electronic commerce (e-commerce) consumer to make a purchase from a merchant for the delivery of the purchase in a package, where: (i) the incentive is a commitment from the merchant, or an ally of the merchant or the consumer, including a delivery service that is to deliver the package, to make a donation to an entity designed by the consumer; (ii) the e-commerce consumer is allowed to use any one of several different merchant websites to check-out so as to purchase the selected goods and services in the shopper's virtual shopping cart that the shopper selected from any of the several different merchant websites; (ii) the e-commerce consumer avoids interacting with third party vendors, such as when performing an electronic checkout function with the shopper's virtual shopping cart, where the third party vendors are unrelated and unconnected; and (iii) the e-commerce consumer is allowed to shop with different merchants at different webpages without requiring the shopper to use a separate permission or log-in for each different merchant.

Further implementations included improvements to the implementations disclosed in U.S. Pat. No. 10,977,604, titled “Systems for routing and controlling vehicles for freight,” issued on Apr. 13, 2021, which is incorporated herein by reference. In such improvements, one or more delivery services that are involved in delivering a package may be obligated to make a donation. In improvements, an electronic commerce (e-commerce) consumer has made a purchase from a merchant for the delivery of the purchase in the package, where an incentive is offered to the consumer by the one or more delivery services to make a donation to an entity designed by the consumer.

In the implementations disclosed herein, it is preferable that the electronic commerce (e-commerce) consumer that makes a purchase in a transaction with a merchant for the delivery of the purchase in a package by a delivery service will have the ability to designate an affinity entity to whom a financial donation is to be made by each of the merchant and the delivery service. It is also preferable that the affinity entity designated by the e-commerce consumer will have a geographic location within in the same local community as the physical address corresponding to the e-commerce consumer. By way of example, but not by way of limitation, the affinity entity designated by the e-commerce consumer may be the consumer's favorite charity that has a geographic location within in the same local community as the physical address corresponding to the e-commerce consumer.

In yet other implementations, the affinity entity to whom a financial donation is to be made by each of the merchant and the delivery service, which affinity entity is selected by the consumer, can be a governmental entity to whom the merchant owes the repayment of a debt. By way of example, and not by way of limitation, the governmental entity may have provided financial support to employed and self-employed citizen who is a merchant that was affected by a national emergency and has received loaned funds over a period of time from the government. In such implementations, the government loan repayment may be made by the consumer making a choice to have the merchant and/or delivery service donations be made towards repayment of the merchant's government loan that the merchant-borrower is obligated to pay back. As such, the consumer can decide to let these donations go to pay off the merchant's government loan instead of the donation being directed towards a different affinity entity.

Once physical addresses of both the merchant and the e-commerce consumer are known, the local community of each of the merchant and the e-commerce consumer can be determined. The local community determination can be made on any of several different methods, or combinations thereof. Once such method is political in that the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same or within a predetermined proximity as that of the e-commerce consumer's residence.

Yet another such comparison can be whether the merchant's place of business and its customer's residence are physically proximate within a predetermined factor by any of a variety of measures or combinations thereof. For example, latitude and longitude coordinates might be known for both the merchants place of business and the residence of its customer (or the location of the smart phone). These coordinates can be used to determine whether the linear distance there between is within a predetermined distance to ascertain whether or not the merchant and its customer share the same local community.

Alternatively, a navigation algorithm, using any of various different travel methods (e.g., walking, automobile, bicycle, mass transit, etc.), may be used to determine whether the time, using one or more travel methods, is within a predetermined time limit to ascertain whether or not the merchant and its customer share the same local community. By way of example the merchant and its customer might be determined to be within the same local community if the automobile drive time, as determined from one or more databases of contemporary cartographic road system information, to navigate between the merchant's brick and mortar store and the customer's residence is less than a predetermined time threshold (e.g., 17 minutes).

A further alternative implementation may identify the population density of both the merchant's brick and mortar store and the customer's residence. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes).

Still another such comparison can be whether the merchants place of business and its customer's residence are proximate according to voting, electoral, or political districts. The district use can be determined by an official method, an unofficial method, or a combination of method. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owns and leased properties, etc. Given the foregoing, a community module (of e.g. donation utility 26 of FIG. 10) might determine that the merchant and its customer are members of the same community, not members of the same community, or are both members of more than one of the same communities as determined by the algorithm.

Referring again now to FIG. 3, further illustrations are seen of a telecommunications network that may make use of any suitable telecommunications network and may involve different hardware, different software and/or different protocols then those discussed below. FIG. 3 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

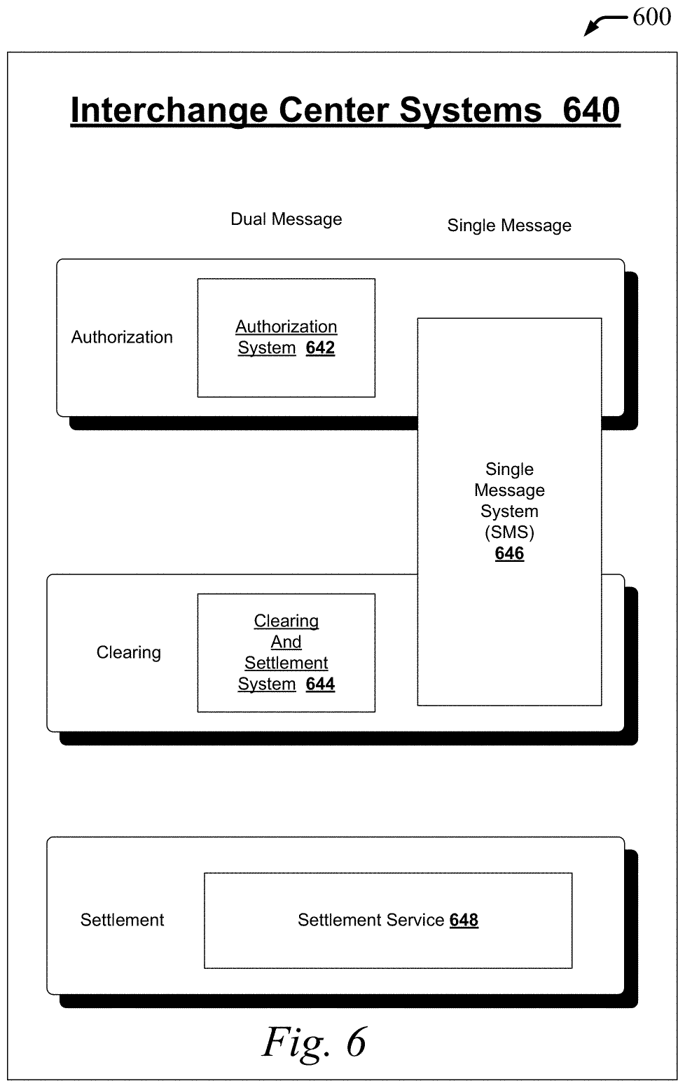

Referring now to FIGS. 1, 3, and 6-7, FIG. 3 includes access points 330, 332 between Transaction Handler 302 and each Acquirer (i) 306 and Issuer (j) 304. Other entities such as drawee banks and third party authorizing agents may also connect to the financial; network through an access point (not shown). An interchange center has systems, such as those seen at reference numeral 640 see in FIG. 6, so as to be a data processing center that may be located anywhere in the world. Each interchange center houses the computer system that performs the network transaction processing. The interchange center serves as the control point for the telecommunication facilities of the network, which comprises high-speed leased lines or satellite connections, for instance as may be based on IBM SNA protocol. Preferably, the communication lines that connect an interchange center (Transaction Handler 302) to remote entities use dedicated high-bandwidth telephone circuits or satellite connections, for instance as may be based on the IBM SNA-LUO communication protocol. Messages are sent over these lines using any suitable implementation of the ISO 8583 standard.

Access points 330, 332 are typically made up of small computer systems located at a processing center that interfaces between the center's host computer and the interchange center system 640. The access point facilitates the transmission of messages and files between the host and the interchange center supporting the authorization, clearing and settlement of transaction. Telecommunication links between the Acquirer (i) 396 and its access point 332, and between the access point 330 and Issuer (j) 304 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. In addition, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

FIG. 6 illustrates Interchange Center systems 640 housed within an interchange center to provide on-line and off-line transaction processing. For dual message transaction, authorization system 642 provides authorization. Authorization system 642 supports on-line and off-line functions, and its file includes internal systems tables, a customer database and a merchant central file. The on-line functions of system 642 support dual message authorization processing. This processing involves routing, account holder and card verification and stand-in processing, and other functions such as file maintenance. Reporting includes authorization reports, exception file and advice file reports, POS reports and billing reports. A bridge from system 642 to a Single Message System (SMS) 646 makes it possible for issuers and acquirers to use system 642 to communicate with other issuers and acquirers using system 646 and access the SMS gateways to outside networks.

Clearing and settlement system 644 clears and settles previously authorized dual message transactions. System 644 collects financial and non-financial information and distributes reports between members. It also calculates fees, charges and settlement totals and produces reports to help with reconciliation. A bridge forms an interchange between system 644 processing centers and system 648 processing centers.

Single message system 646 processes full financial transactions and can also process dual message authorization and clearing transactions, as well as communicate with system 642 using a bridge and accesses outside networks as required. System 646 processes cashless issued account-based acquired transactions, for instance Visa, Plus, Interlink. Maestro, Cirrus, and others. By way of example, SMS files comprise internal system tables that control system access and processing, and an account holder database, which contains files of account holder data used for Personal IDentifier (PIN) verification and stand-in processing authorization. System 646 has on-line functions that perform real-time account holder transaction processing and exception processing for authorization as well as full financial transactions. System 646 also accumulates reconciliation and settlement totals. System 646 also has off-line functions that process settlement and funds transfer requests and provide settlement and activities reporting. Settlement service 648 consolidates the settlement functions of system 644 and 646 for cashless issued account-based acquired transactions into a single service for all products and services. Clearing continues to be performed separately by system 644 and system 646.

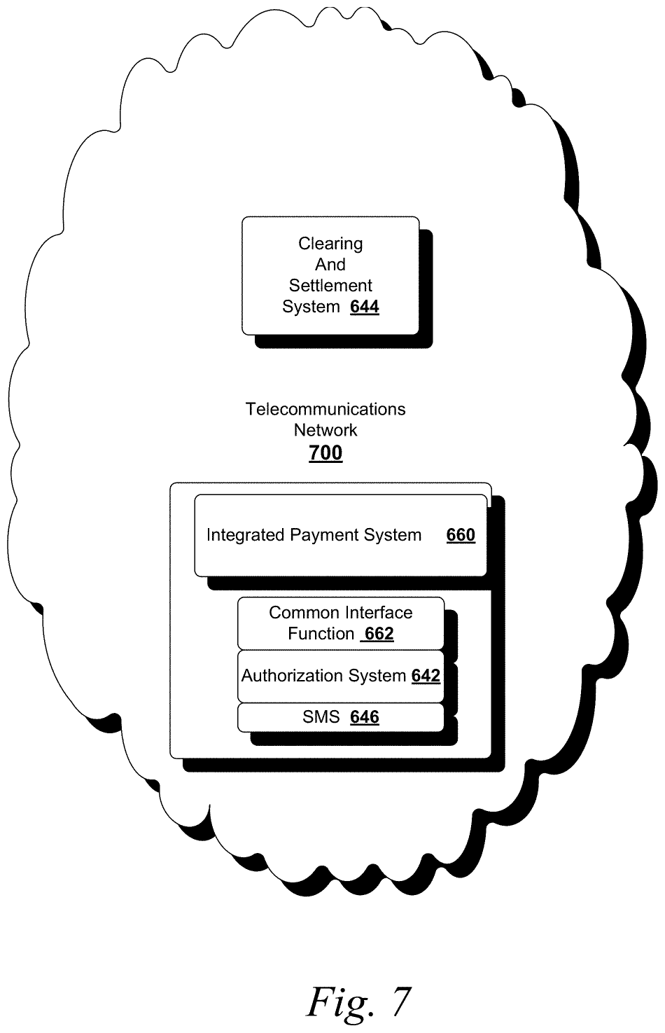

FIG. 7 illustrates another view of components of FIG. 6 in a telecommunications network 700. Integrated payment system 760 is the primary system for processing all on-line authorization and financial request transactions. System 760 reports both dual message and single message processing. In both cases, settlement occurs separately. The three main software components are the common interface function 762, authorization system 742 and single message system 746.

Common interface function 762 determines the processing required for each message received at an interchange center. It chooses the appropriate routing, based on the source of the message (system 742, 744 or 746), the type of processing request and the processing network. This component performs initial message editing, and, when necessary, parses the message and ensures that the content complies with basic message construction rules. Common interface function 762 routes messages to their system 742 or system 746 destinations.

Referring again now to FIGS. 1, 3, and 6-7, further illustrations are seen of a telecommunications network that may make use of any suitable telecommunications network and may involve different hardware, different software and/or different protocols then those discussed below. FIGS. 1, 3, and 6-7 can include a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some of the Implementation Permutations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

What is claimed is:

1. A method comprising:
receiving access to a merchant website corresponding to a merchant to conduct a transaction for a purchase to be delivered in a package to a physical address corresponding to an account holder by a delivery service, wherein both the delivery service and the merchant corresponding to the merchant website from whom the purchase is purchased in a transaction has agreed to make a financial donation;
receiving, after delivery of the package to the physical address by the delivery service, at a logical address corresponding to the account holder:
chain of custody blockchain data sufficient to uniquely identify:
the purchase in the package;
the merchant from whom the purchase in the package was purchased in the transaction; and
the delivery service that delivered the package to the physical address corresponding to the account holder; and
a survey;
receiving feedback in response to the survey in respect to the purchase and the delivery of the package submitted with the survey; and
transmitting the feedback in response to the survey.

2. The method as defined in claim 1, wherein the chain of custody blockchain data includes information identifying tamper evident packaging in which the package was delivered to the physical address corresponding to the account holder.

3. The method as defined in claim 1, wherein the transaction with the merchant is conducted on account issued to the account holder by an issuer.

4. The method as defined in claim 1, wherein:
the financial donation is to be made to an affinity entity designated by the account holder; and
the affinity entity has a geographic location within in the same local community as the physical address corresponding to the account holder.

5. The method as defined in claim 4, wherein the affinity entity has a geographic location within in the same local community as the physical address corresponding to the account holder by determining a navigation time between the respective physical addressed corresponding to the account holder and the affinity entity.

6. The method as defined in claim 5, wherein the navigation time is determined for a transportation mode selected from the group consisting of walking, automobile, bicycle, mass transit, and a combination thereof.

7. The method as defined in claim 1, further comprising:
receiving access to one or more different said merchant websites to conduct the transaction for the purchase, wherein the purchase includes at least one item to be delivered in the package to the physical address corresponding to the account holder by the delivery service;
enabling the selection of the at least one item from at any of the one or more different said merchant websites without requiring the user to use a separate permission or log-in for each different merchant from whom the at least one item is to be purchased; and
enabling a check-out process for the purchase at any of the one or more different merchant websites t thereby avoid interacting with each said merchant from whom the at least one item is purchased in the transaction.

8. A non-transient computer-readable medium having encoded thereon software which, when executed by hardware, performs the method of claim 1.

9. A method comprising:
serving a merchant website corresponding to a merchant to a web browser to enable a user thereof to enter a request to make a purchase to be delivered in a package to a physical address corresponding to an account holder by a delivery service, wherein both the delivery service and the merchant corresponding to the merchant website from whom the purchase is purchased in a transaction has agreed to make a financial donation;
receiving data reflective that the transaction was conducted on an account;
generating chain of custody blockchain data sufficient to uniquely identify:
the purchase in the package;
the merchant from whom the purchase in the package was purchased in the transaction; and
the delivery service that delivered the package to the physical address corresponding to the account holder;
and
serving, after delivery of the package to the physical address by the delivery service, to the web browser a survey.

10. The method as defined in claim 8, wherein the chain of custody blockchain data includes information identifying tamper evident packaging in which the package was delivered to the physical address corresponding to the account holder.

11. The method as defined in claim 8, wherein for the receiving data reflective that the transaction was conducted on the account comprises:
receiving an authorization request for the transaction on the account between the account holder and the merchant corresponding to the merchant website from whom the purchased is purchased in the transaction; and
receiving an authorization response to the authorization request indicating that the transaction was authorized by an account issuer that issued the account to the account holder upon which the transaction was conducted by the account holder.

12. The method as defined in claim 8, wherein:
the financial donation is to be made to an affinity entity designated by the account holder; and
the affinity entity has a geographic location within in the same local community as the physical address corresponding to the account holder.

13. The method as defined in claim 12, wherein the affinity entity has a geographic location within in the same local community as the physical address corresponding to the account holder by determining a navigation time between the respective physical addressed corresponding to the account holder and the affinity entity.

15. The method as defined in claim 13, wherein the navigation time is determined for a transportation mode selected from the group consisting of walking, automobile, bicycle, mass transit, and a combination thereof.

16. The method as defined in claim 8, further comprising:
providing the user access to one or more different merchant websites to conduct the transaction for the purchase, wherein the purchase includes at least one item to be delivered in the package to the physical address corresponding to the account holder by the delivery service;
providing the user access to select the at least one item from at any of the one or more different merchant websites without requiring the user to use a separate permission or log-in for each different merchant from whom the at least one item is to be purchased; and
providing the user access to a check-out process for the purchase at any of the one or more different merchant websites such that the user avoids interacting with each said merchant from whom the at least one item is purchased in the transaction.

17. A non-transient computer-readable medium having encoded thereon software which, when executed by hardware, performs the method of claim 8.

18. An Internet server hardware system performing a method comprising a plurality of steps that include:
serving a merchant website corresponding to a merchant to a web browser to enable a user thereof to enter a request to make a purchase to be delivered in a package to a physical address corresponding to an account holder by a delivery service, wherein both the delivery service and the merchant corresponding to the merchant website from whom the purchase is purchased in a transaction has agreed to make a financial donation to an entity designated by the account holder;
receiving data reflective that the transaction was conducted on an account;
generating chain of custody blockchain data sufficient to uniquely identify:
the purchase in the package;
the merchant from whom the purchase in the package was purchased in the transaction; and
the delivery service that delivered the package to the physical address corresponding to the account holder;
and
serving, after delivery of the package to the physical address by the delivery service, to the web browser a survey.

19. The method as defined in claim 18, further comprising:
providing the user access to one or more different merchant websites to conduct the transaction for the purchase, wherein the purchase includes at least one item to be delivered in the package to the physical address corresponding to the account holder by the delivery service;
providing the user access to select the at least one item from at any of the one or more different merchant websites without requiring the user to use a separate permission or log-in for each different merchant from whom the at least one item is to be purchased; and
providing the user access to a check-out process for the purchase at any of the one or more different merchant websites such that the user avoids interacting with each said merchant from whom the at least one item is purchased in the transaction.

20. The Internet server hardware system as defined in claim 18, wherein:
the financial donation is to be made to an affinity entity designated by the account holder;
the affinity entity has a geographic location within in the same local community as the physical address corresponding to the account holder; and
the affinity entity has a geographic location within in the same local community as the physical address corresponding to the account holder by determining a navigation time between the respective physical addressed corresponding to the account holder and the affinity entity.
